(19) United States
(12) Patent Application Publication
(10) Pub. No.: US 2006/0160611 A1
(43) Pub. Date: Jul. 20, 2006

(54) Gaming machine and gaming system

(75) Inventor: Kazuo Okada, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ARUZE Corp., Koto-ku (JP)

(21) Appl. No.: 11/294,514

(22) Filed: Dec. 6, 2005

(30) Foreign Application Priority Data
Dec. 10, 2004 (JP) 2004-358686

(51) Int. Cl. A63F 13/00

(52) U.S. Cl. 463/25; 463/20; 463/21

(57) ABSTRACT

A gaming machine and gaming system having a rate setting function, wherein people other than a player can be made to recognize a set rate.

A slot machine 1A pays out an award corresponding to a preset set rate out of a plurality of possible set rates. The slot machine 1A includes an 1C chip reader/writer 12c for reading stored rate type information from a FIG. 70A, 70B storing rate type information A, B indicating each rate, and a rate setting unit for setting as a set rate a rate from the plurality of rates which corresponds to the rate type information A, B read by the 1C chip reader/writer 12c.

### RELATED APPLICATIONS

This application claims the priority of Japanese Patent Application No.2004-358686 filed on Dec. 10, 2004, which is incorporated by reference.

### BACKGROUND OF THE INVENTION

1. Technical Field

The present invention relates to a gaming machine and a gaming system which have the function of reading information stored in a gaming article and the function of setting a rate using the information read.

2. Related Art

In general, the rate (the unit value of a game medium, such as a coin, which is required to set one pay line as an activated pay line, or the unit of one credit) of a gaming machine is predetermined, and a player must play a game in accordance with the predetermined rate. However, a gaming machine has heretofore existed which has a rate setting function in which the rate is switched among a plurality of prepared rates in response to a player's input. For example, U.S. Pat. No. 6,506,116 discloses a gaming machine capable of setting the rate at any one of $1, ¢25, and ¢50 by depressing a rate switching switch.

However, in the aforementioned existing gaming machine, the rate is set as the player operates the rate switching switch. Therefore, the setting of rates inevitably falls under the player's initiative, which does not require the engagement of any component other than the player. For this reason, it is difficult for people other than the player to notice the set rates, which creates the possibility that, in particular, a player who has the desire to appeal to people around him/her that he/she is playing at a high amount rate, feels the game unsatisfactory or even uninteresting.

### SUMMARY OF THE INVENTION

Therefore, the invention has been made to solve the aforementioned problem, and an object of the invention is to provide a gaming machine and a gaming system which, having a rate setting function, is configured capable of allowing people other than a player to recognize a set rate.

To achieve the aforementioned object, according to a first aspect of the invention, a gaming machine, which pays out an award corresponding to a preset set rate out of a plurality of possible set rates, comprises a reading unit and a rate setting unit. The reading unit reads, from a gaming article which stores rate type information indicating the type of each of the rates, the rate type information stored therein. The rate setting unit sets, as the set rate, a rate out of the plurality of rates which corresponds to the rate type information read by the reading unit.

In this gaming machine, the rate thereof is set in response to the rate type information stored in the gaming article. Therefore, the rate is set in response to the kind of the gaming article, so that the set rate corresponds to the kind of the gaming article, thus making it possible to recognize the set rate from the appearance of the gaming article.

As described in detail above, according to the gaming machine and gaming system of the invention, a rate can be set, and people other than the player can be made to recognize the set rate.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DISCLOSURE OF THE INVENTION

According to a first aspect of the invention, a gaming machine, which pays out an award corresponding to a preset set rate out of a plurality of possible set rates, comprises a reading unit and a rate setting unit. The reading unit reads, from a gaming article which stores rate type information indicating the type of each of the rates, the rate type information stored therein. The rate setting unit sets, as the set rate, a rate out of the plurality of rates which corresponds to the rate type information read by the reading unit.

In this gaming machine, the rate thereof is set in response to the rate type information stored in the gaming article. Therefore, the rate is set in response to the kind of the gaming article, so that the set rate corresponds to the kind of the gaming article, thus making it possible to recognize the set rate from the appearance of the gaming article.

According to a first aspect of the invention, the gaming machine further comprises a rate storage unit in which the rate type information and rate groups, each including a plurality of rates, are stored related to one another. The rate setting unit reads from the rate storage unit any one of a plurality of rates included in a rate group corresponding to the rate type information read by the reading unit, and sets the read rate as the set rate.

In this gaming machine as well, the rate thereof is set in response to the rate type information stored in the gaming article. Therefore, the rate is set in response to the kind of the gaming article, so that the set rate corresponds to the kind of the gaming article, thus making it possible to recognize the set rate from the appearance of the gaming article. Furthermore, the rate groups, each including a plurality of rates, are stored related to one another. Therefore, the player can play with one gaming article at a plurality of rates without possessing a plurality of gaming articles.

According to a third aspect of the invention, the gaming machine of the second aspect further comprises a display unit and a rate selection unit. The display unit displays a plurality of rates included in a rate group corresponding to the rate type information read by the reading unit. The rate selection unit is used for a player to select any one of a plurality of rate displayed on the display unit. The rate setting unit sets as the set rate the rate selected by the rate selection unit.

With such a configuration, in playing, the player can select his/her desired rate from the plurality of rates which correspond to the rate type information stored in the gaming article.

According to a first aspect of the invention, in the gaming machine, the reading unit can read, from a gaming article which stores rate type information indicating the type of each of the rates and use history information indicating a use history, the rate type information and the use history information which are stored therein. The rate setting unit sets as the set rate a rate out of the plurality of rates which corresponds to the rate type information and the use history information which have been read by the reading unit.

In this gaming machine as well, the rate thereof is set in response to the rate type information stored in the gaming article. Therefore, the rate is set in response to the kind of the gaming article, so that the set rate corresponds to the kind of the gaming article, thus making it possible to recognize the set rate from the appearance of the gaming article. Besides, in addition to the rate type information, the rate of the gaming machine is set in response to the use history information of the gaming article, so that the rate is set in response to the use history of the gaming article.

According to a fifth aspect of the invention, in the gaming machine of any one of the first to fourth aspects, the rate setting unit, when the rate type information is not read by the reading unit, sets as the set rate an initial set rate of the lowest value of any of the rates.

With such a configuration, a rate can be set even when the rate of the gaming article is not read.

According to a sixth aspect of the invention, a gaming system comprises: a gaming machine which pays out an award corresponding to a preset set rate out of a plurality of possible set rates; and a server which communicates with the gaming machine. The gaming machine includes a reading unit and a transmission unit. The reading unit reads, from a gaming article which stores rate type information indicating the type of each of the rates and use history information which indicates a use history, the rate type information and the use history information which are stored therein. The transmission unit transmits to the server the rate type information and the use history information which have been read by the reading unit. The server includes a receiving unit and a rate transmission unit. The receiving unit receives the rate type information and the use history information which have been transmitted by the transmission unit. The rate transmission unit transmits, to the gaming machine, rate information which indicates a rate corresponding to the rate type information and the use history information which have been received from the receiving unit.

In this gaming system as well, the rate of the gaming machine is set in response to the rate type information stored in the gaming article. Therefore, the rate is set in response to the kind of the gaming article, so that the set rate corresponds to the kind of the gaming article, thus making it possible to recognize the set rate from the appearance of the gaming article.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

FIG. 1 is a perspective view showing the overall configuration of a slot machine, which is a gaming machine, according to a first embodiment;

FIG. 2 is a front view showing a main display of the slot machine shown in FIG. 1;

FIG. 3 is a perspective view showing the configuration of reels;

FIG. 4 is a perspective view showing one of the reels shown in FIG. 3;

FIG. 5 is a perspective view showing the outlined configuration of a liquid crystal display device as seen from the back side of a cabinet;

FIG. 6 is an exploded perspective view of a portion of the liquid crystal display device;

FIG. 7 is a block diagram of the slot machine according to the first embodiment, showing its main internal configuration;

FIG. 8 is a diagram showing the content of a first rate table;

FIG. 9 is a block diagram showing an image control circuit;

FIGS. 10A and 10B are exploded perspective views showing the configurations of figures, wherein FIG. 10A shows a figure representing a high rate, and FIG. 10B shows a figure representing a low rate;

FIG. 11 is a flowchart showing the operational procedure of a main process from the start to the end of a game on the slot machine according to the first embodiment;

FIG. 12 is a flowchart showing the operational procedure of a game start process shown in FIG. 11;

FIG. 13 is a flowchart showing the operational procedure of a rate setting process shown in FIG. 11;

FIG. 14 is a diagram showing the content of a second rate table;

FIG. 15 is a flowchart showing the operational procedure of a main process from the start to the end of a game on a slot machine according to a second embodiment;

FIG. 16 is a flowchart showing the operational procedure of a game start process shown in FIG. 15;

FIG. 17 is a flowchart showing the operational procedure of a rate setting process shown in FIG. 15;

FIG. 18 is a flowchart showing the operational procedure of a game end process shown in FIG. 15;

FIG. 19 is a perspective view showing the overall configuration of a slot machine, which is the gaming machine, according to a third embodiment;

FIG. 20 is a block diagram of the slot machine according to the third embodiment, showing its main internal configuration;

FIG. 21 is a system configuration diagram of a gaming system including a plurality of the slot machines and a shop server; and

FIG. 22 is a sequence chart showing the operation sequence performed between the slot machines and a shop server.

### DESCRIPTION OF THE PREFERRED EMBODIMENT(S)

Embodiments of the invention will hereafter be described. Like components are identified by like reference numerals to avoid redundant description.

### First Embodiment

In a first embodiment, the following slot machine 1A will be described as an example in which the invention is applied to a gaming machine which has a variable display unit for variably displaying a plurality of symbols using mechanical reels. This slot machine 1A is adapted to require coins to be inserted in order to start a game.

### Overall Configuration of Slot Machine

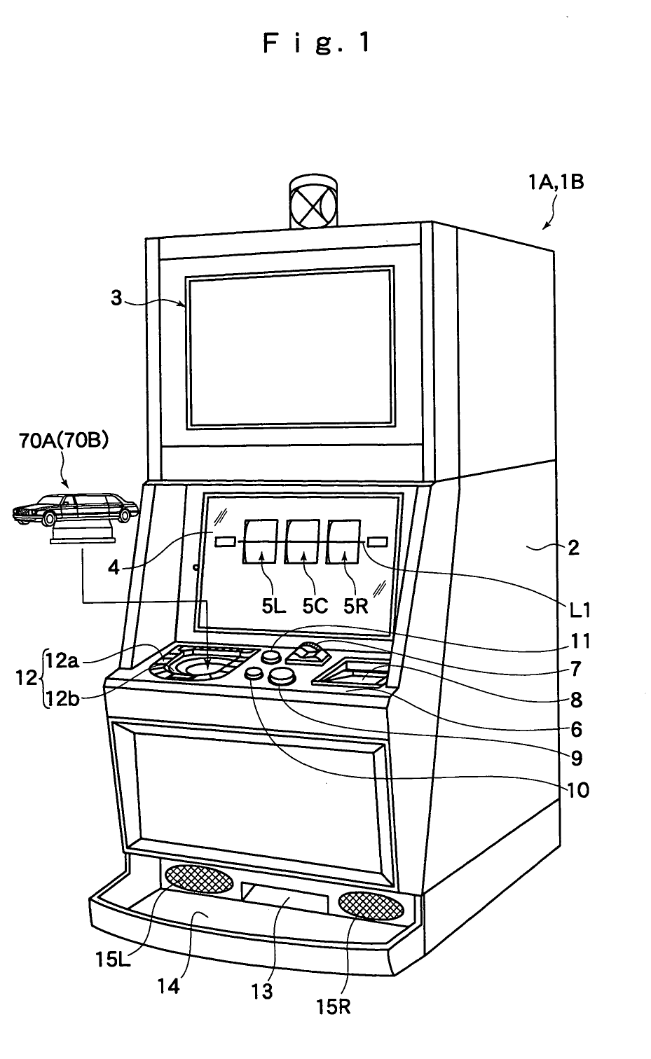

The overall configuration of the slot machine 1A will first be described with reference to FIG. 1. FIG. 1 is a perspective view showing the overall configuration of the slot machine 1A according to the first embodiment.

The slot machine 1A, which is the gaming machine of the invention, has, on the front side of a casing 2, a sub-display 3 and a main display 4 in the order named from the top. The main display 4 is vertically located in the approximately central portion of a casing 2. Inside the casing 2, three mechanical reels 5L, 5C, and 5R are rotatably arranged in a horizontal row so as to face this main display 4.

The reels 5L, 5C, and 5R are rendered visible from the outside through symbol display regions described later 21L, 21C, and 21R in the main display 4. A symbol column (not shown) having plural kinds of symbols is displayed on the periphery of each of the reels 5L, 5C, and 5R. Although described later in detail, the reels 5L, 5C, and 5R, each configuring variable display unit rotatable to variably display the symbols, rotate at a set speed (e.g., 80 revolutions per minute).

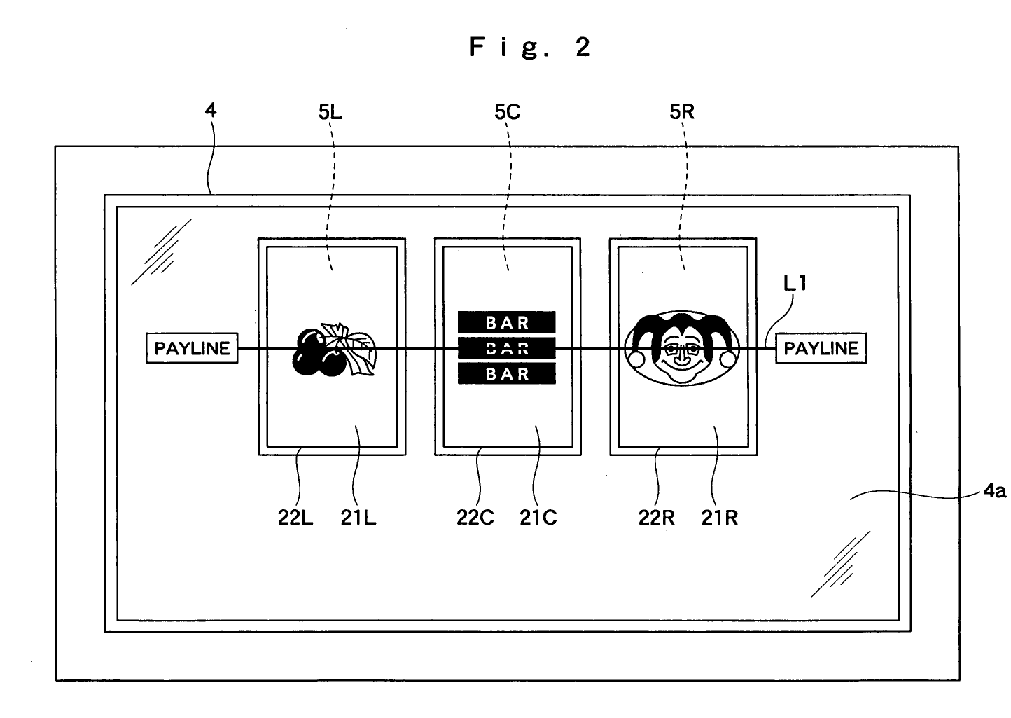

Relative to the reels 5L, 5C, and 5R, as shown in FIG. 2, one horizontally extending pay line L1 is provided in the symbol display regions 21L, 21C, and 21R. Although not shown, in addition to this pay line L1, two other pay lines may be provided above and below the pay line LI, respectively. In this case, two more pay lines may be diagonally provided. When a plurality of pay lines are provided, the number of pay lines can be adapted to vary depending on the number of coins inserted. In this case, the pay lines are each rendered active according to the number of coins inserted and the operation of a to-be-described BET switch 10, 11. Any pay line rendered active is also called an activated pay line. For example, when a player inserts one coin into a to-be-described coin insertion slot 7, only the central pay line L1 becomes an activated pay line. When the player inserts two coins, the upper and lower pay lines are added thereto, and when the player inserts three coins, all the pay lines become activated pay lines. To facilitate visualization, FIG. 2 shows the state in which symbols are stopped on only the pay line L1. Normally, however, three symbols are displayed, vertically arranged, in each of the symbol display regions 21L, 21C, and 21R.

In addition, the slot machine 1A has a generally horizontal operation panel 6 provided below the main display 4. The operation panel 6 is provided with the coin insertion slot 7, a bill insertion slot 8, a SPIN switch 9, a 1BET switch 10, a MAXBET switch 11, and a figure setting unit 12.

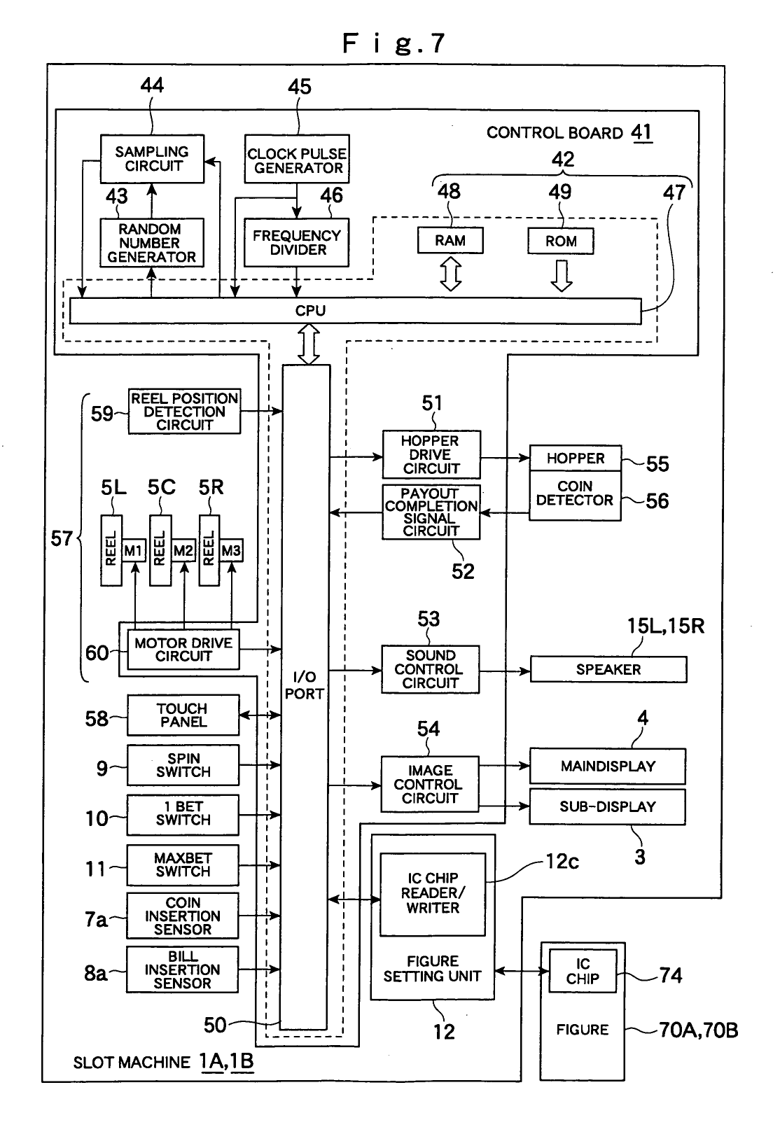

The coin insertion slot 7, provided for the player to insert coins to be bet in a game, has a coin insertion sensor 7a (see FIG. 7) for transmitting a signal indicative of coin insertion. The bill insertion slot 8, provided for the player to insert bills, has a bill insertion sensor 8a (see FIG. 7) for transmitting a signal indicative of bill insertion. The SPIN switch 9 is provided for the player to perform the operation to start the rotation of the reels 5L, 5C, and 5R and thereby the variable display of symbols in the symbol display regions 21L, 21C, and 21R, thus starting the game. The 1BET switch 10 is provided for placing the bet of one coin in a single operation. The MAXBET switch 11 is provided for placing the bet of the maximum number of coins which can be bet in one game.

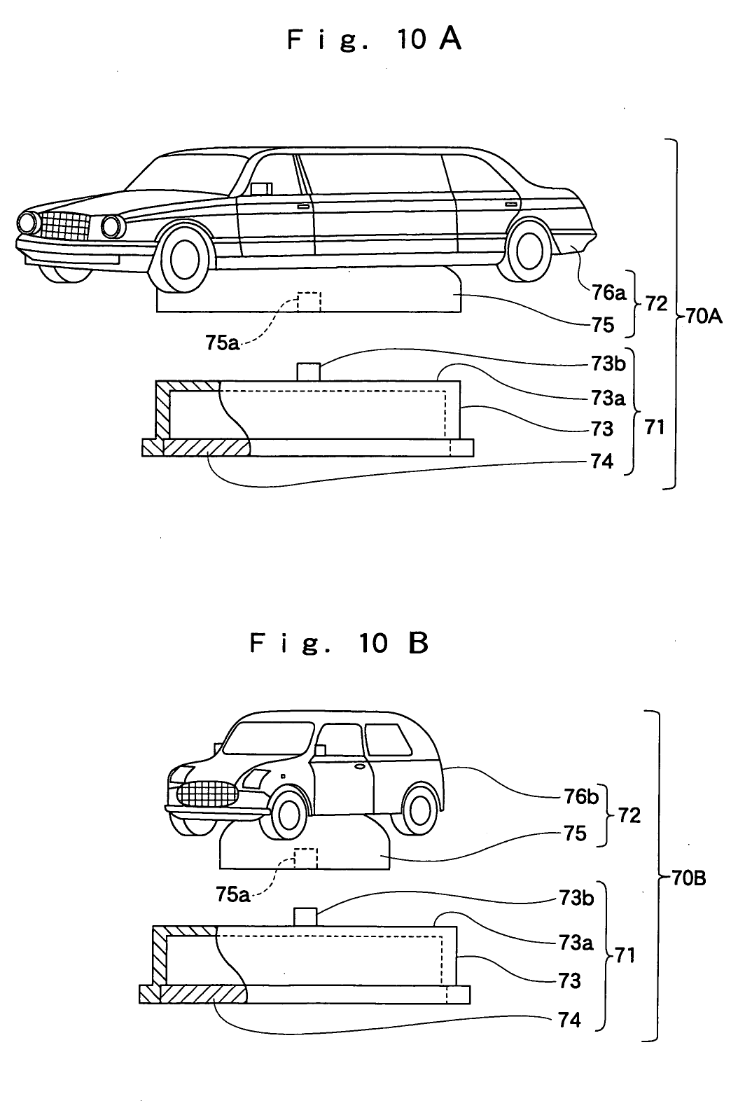

In addition, the figure setting unit 12 has a pedestal setting portion 12a fixed to the surface of the operation panel 6 and a reader/writer portion 12b. This pedestal setting portion 12a, having inside it a depression which corresponds to the shape of a thick disk-like pedestal 71 of a to-be-described FIG. 70A, 70B (see FIG. 10), is adapted such that the pedestal 71 can be fitted into this depression. The reader/writer portion 12b is located in the depression of the pedestal setting portion 12a, while an 1C chip reader/writer 12c (see FIG. 7) is provided inside the figure setting unit 12.

In addition, the slot machine 1A includes, provided at the bottom of the casing 2, a coin payout opening 13 and a coin receiving tray 14 for receiving coins paid out. Furthermore, speakers 15L and 15R are provided on the left and right sides, respectively, of the coin payout opening 13.

### Description of Each Display

As shown in FIG. 2, the main display 4 has the symbol display regions 21L, 21C, and 21R, window frame display regions 22L, 22C, and 22R, and an effect display region 4a. The display content on the main display 4 is adapted to vary in response to the variable display or stop mode of the reels 5L, 5C and 5R and the operational content of the slot machine 1A.

The symbol display regions 21L, 21C, and 21R, provided so as to correspond to the reels 5L, 5C, and 5R, are regions in which symbols displayed on the reels 5L, 5C, and 5R are visibly displayed. The symbol display regions 21L, 21C, and 21R are adapted, when the corresponding reels 5L, 5C, and 5R are rotating and when the rotation is stopped, such that a transmission display, which enables the player to see the scrolling reels 5L, 5C, and 5R and the symbols displayed thereon, is performed therein, and such that an effect display with a static image or a dynamic image, such as a symbol, a letter, a graphic, a mark, or a character, is not performed therein.

The window frame display regions 22L, 22C, and 22R, provided surrounding the corresponding symbol display regions 21L, 21C, and 21R, function as the display window frame of the symbols displayed on the reels 5L, 5C, and 5R.

In the effect display region 4a are displayed an effect for increasing a player's interest and information used for the player to proceed with the game to his/her advantage.

The sub-display 3, adapted such that its display content varies in response to the operational content of the slot machine 1A, displays an image (e.g., game instructions) not directly involved in the game.

### Configuration of Reels

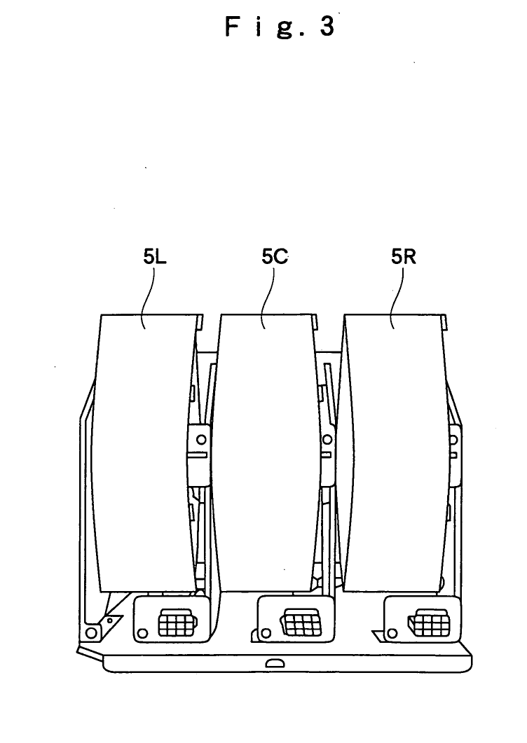

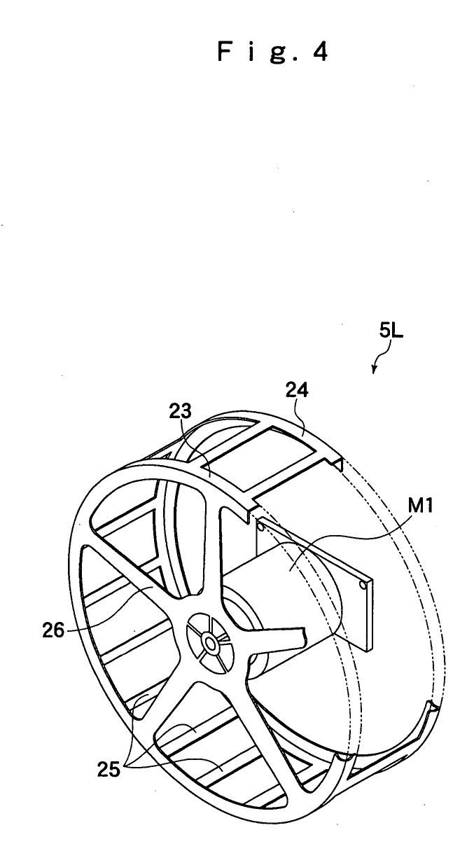

The configuration of the reels 5L, SC, and 5R will now be described with reference to FIGS. 3 and 4. FIG. 3 is a perspective view showing the configuration of the reels 5L, 5C, and 5R. FIG. 4 is a perspective view showing the reel 5L as an example of the reels 5L, 5C, and 5R shown in FIG. 3.

As shown in FIG. 3, the reels 5L, 5C, and 5R, arranged in a row horizontally, are each adapted to be rotatable. As shown in FIG. 4, the reel 5L includes a cylindrical frame configured such that two annular frames 23 and 24 of the same shape are spaced a predetermined distance from one another and connected by a plurality of connecting members 25. In addition, as shown in FIG. 4, the reel 5L includes a transmission member 26 for transmitting to the annular frames 23 and 24 the driving force of a stepping motor M1 (see FIG. 7) located in the core section of the cylindrical frame. A reel sheet (not shown) is attached to side surface portions of the connecting members 25 so as to cover the connecting members 25. A plurality of symbols (not shown) are displayed on the reel sheet. The reels 5C and 5R have the same configuration as the reel 5L.

### Description of Liquid Crystal Display Device

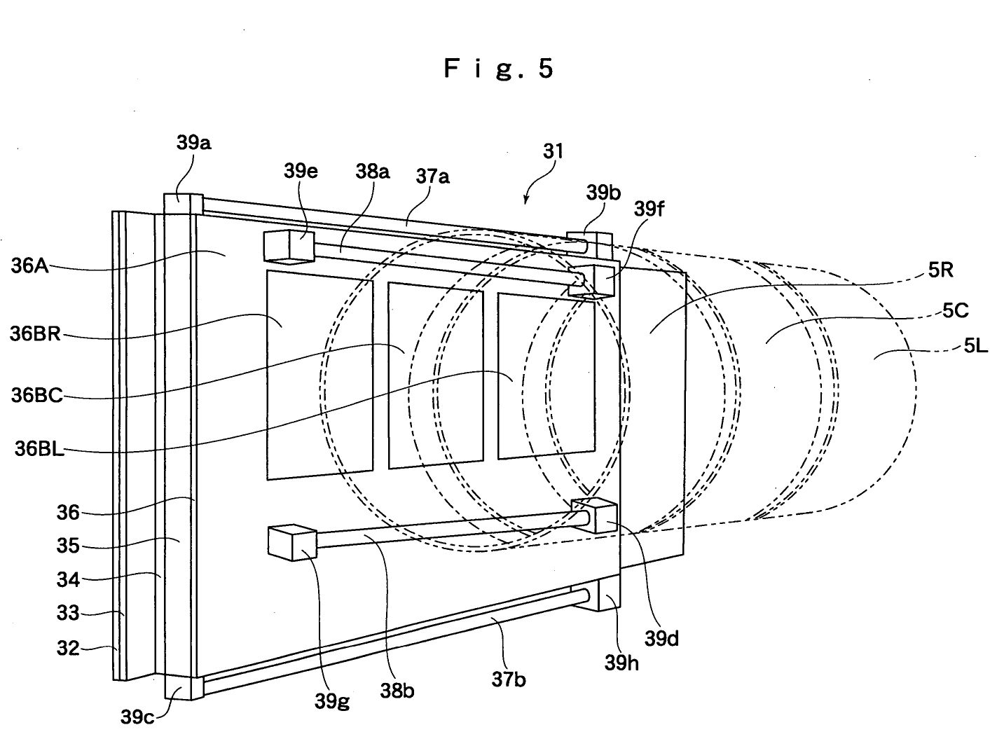

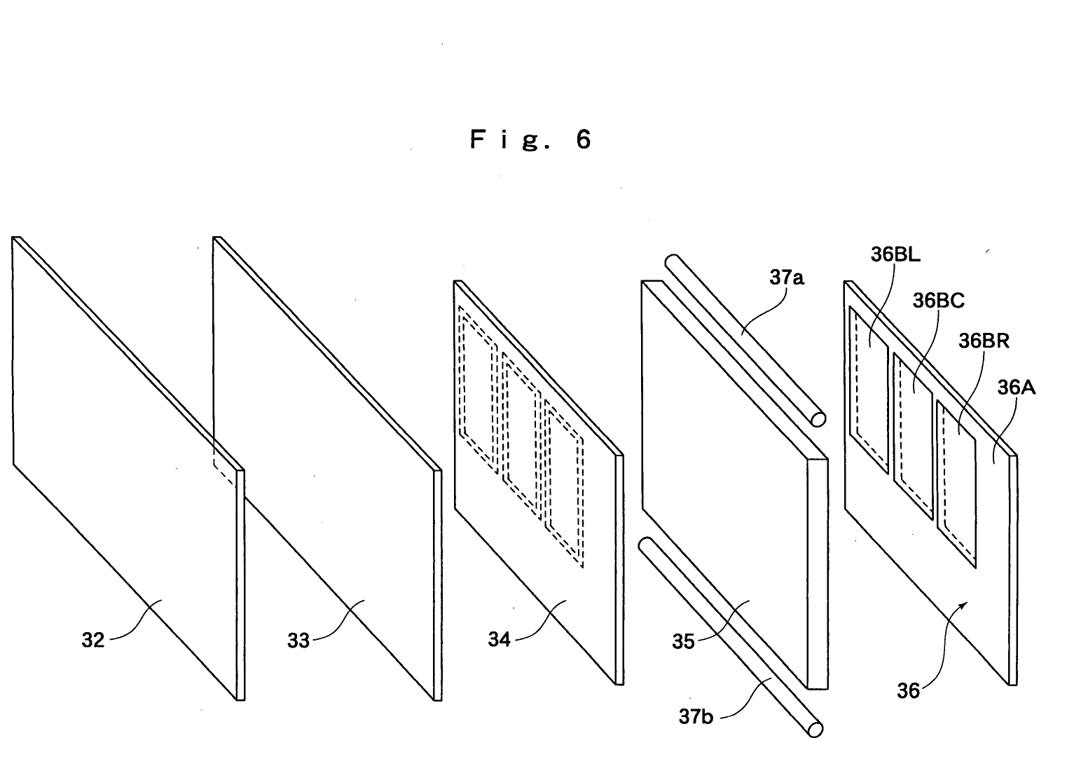

A liquid crystal display device 31 configuring the main display 5 will now be described with reference to FIGS. 5 and 6. FIG. 5 is a perspective view showing the outlined configuration of the liquid crystal display device 31, as seen from the back side of the casing 2. FIG. 6 is a partial exploded perspective view of the liquid crystal display device 31.

The liquid crystal display device 31, spanning the reels 5L, 5C, and 5R, is located in front of them, spaced a predetermined distance from the reels 5L, 5C, and 5R. the liquid crystal display device 31 includes protective glass 32, a display plate 33, a liquid crystal panel 34, a light guide plate 35, a reflective film 36, fluorescent lamps 37a, 37b, 38a, and 38b which are white light sources, lamp holders 39a to 39h, and a flexible board (not shown) including a table carrier package (TCP) which, connected to the terminal of the liquid crystal panel 34, is mounted with an IC for driving the liquid crystal panel 34.

The protective glass 32 and the display plate 33 have transmittivity. The protective glass 32 is provided mainly to protect the liquid crystal panel 34. A predetermined image (not shown) is displayed on the display plate 33.

The liquid crystal panel 34 is configured by sealing a liquid crystal between a transparent substrate, such as a glass plate, formed with a thin: film transistor and a transparent substrate opposite thereto. The liquid crystal panel 34 thus forms the symbol display regions 21L, 21C, and 21R. This liquid crystal panel 34 is configured to have a normally white mode which, with no voltage applied to the liquid crystal (i.e., with the liquid crystal not activated), provides a white display (which transmits light to the display surface side and thus renders the light visible from the outside) to render the reels 5L, 5C, and 5R visible from the observer's side. Provided with the liquid crystal panel 34 configured to have such a normally white mode, the slot machine 1 A is adapted, even when the sealed liquid crystal cannot be activated, such that symbols displayed on the reels 5L, 5C, and 5R are visible through the symbol display regions 21L, 21C, and 21R, and thus such that, observing the variable and stop display of the reels 5L, 5C, and 5R, the game can be played.

The light guide plate 35 having transmittivity, located on the back side of the liquid crystal panel 34, is provided for leading light, coming in from the fluorescent lamps 37a and 37b, to the liquid crystal panel 34.

The reflective film 36 is provided for reflecting the light, led into the light guide plate 35, toward the back side of the light guide plate 35. The reflective film 36 has an evaporated silver film formed on a white polyester film or an aluminum thin film. This reflective film 36 includes a reflective region 36A and non-reflective regions 36BL, 36BC, and 36BR. The reflective region 36A, which reflects incident light, operates as an illumination unit for illuminating principally the region of the liquid crystal panel 34 which corresponds to the window frame display regions 22L, 22C, and 22R and the effect display region 4a. The non-reflective regions 36BS, 36BC, and 36BR, made of a transparent material, are formed as light transmission portions for transmitting the incident light without reflecting it. In addition, the non-reflective regions 36BS, 36BC, and 36BR, formed in response to the symbol display regions 21L, 21C, and 21R, are located in front of the three vertically arranged symbols which appear when the rotation of each of the reels 5L, 5C, and 5R is stopped.

The fluorescent lamps 37a and 37b, located along the upper end portion and the lower end portion of the light guide plate 35, are each supported at both ends by the lamp holders 39a to 39d. The fluorescent lamps 37a and 37b, which generate light to be led into the light guide plate 35, operate as illumination units for illuminating principally the region of the liquid crystal panel 34 which corresponds to the window frame display regions 22L, 22C, 22R and the effect display region 4a.

The fluorescent lamps 38a and 38b, located facing the reels 5L, 5C, and 5R at the upper position and the lower position of the reflective film 36 on the back side thereof, are each supported at both ends by each of the lamp holders 39e to 39h. That is, light emitted from the fluorescent lamps 38a and 38b is to reflect off the surfaces of the reels 5L, 5C, and 5R, fall on the non-reflective regions 36BL, 36BC, and 36BR, and thus illuminate the liquid crystal panel 34. The fluorescent lamps 38a and 38b thereby operate as illumination units for illuminating symbols arranged on the reels 5L, 5C, and 5R and as illumination units for illuminating the region of the reflective film 36 which corresponds to the symbol display regions 21L, 21C, and 21R.

### Internal Configuration of Slot Machine

FIG. 7 is a block diagram of the slot machine 1 showing its main internal configuration. The slot machine 1 includes a plurality of components with a control board 41 forming a core. The control board 41 includes a microcomputer 42, a random number generator 43, a sampling circuit 44, a clock pulse generator 45, and a frequency divider 46.

The microcomputer 42 includes a CPU (Central Processing Unit) 47, a RAM (Random Access Memory) 48, and a ROM (Read Only Memory) 49. The CPU 47 operates as the rate setting unit featuring the invention based on a program stored in the ROM 49, while the CPU 47 transmits/receives signals from the other components via an I/O port 50 and controls the operation of the entire slot machine 1A. The RAM 48 stores data and programs which are used when the CPU 47 is in operation. That is, for example, the RAM 48 holds temporarily, after the game starts, random number values sampled by the to-be-described sampling circuit 44, and stores the code numbers of the reel 5L, 5C, and 5R and symbol numbers.

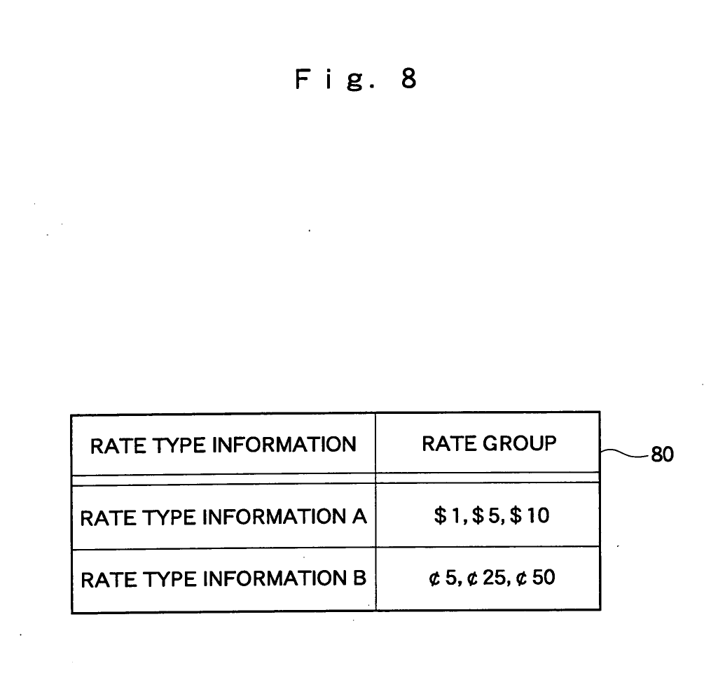

The ROM 49 stores programs to be executed by the CPU 47 and permanent data. In addition, the ROM 49 has the function of serving as the rate storage unit of the invention. That is, the ROM 49 stores a first rate table (see FIG. 8) 80 having to-be-described rate type information A and B related to a plurality of rates. This first rate table 80 contains “A” and “B” as the rate type information, wherein rate groups each having three rates “$1, $5, $10” or “¢05, ¢25, ¢50” are related to “A” and “B”. The initial set rate of the invention is ¢5 which is the lowest of all the rates contained in the rate groups.

The random number generator 43 operates in accordance with an instruction from the CPU 47 and generates a fixed range of random numbers. The sampling circuit 44, in accordance with an instruction from the CPU 47, extracts any random number from among the random numbers generated by the random number generator 43 and transmits the extracted random number to the CPU 47. The clock pulse generator 45 generates a reference clock for operating the CPU 47, and the frequency divider 46 transmits, to the CPU 47, a signal obtained by dividing the reference clock by a fixed frequency.

The control board 41 includes a hopper drive circuit 51, a payout completion signal circuit 52, a sound effect circuit 53, and an image control circuit 54.

The hopper drive circuit 51 drives a hopper 55 in accordance with the control of the CPU 47. The hopper 55 performs a coin payout operation to pay out coins from a payout opening 13.

The payout completion signal circuit 52 receives data consisting of the number of coins from a coin detector 56 connected thereto, and transmits a signal notifying coin payout completion to the CPU 47 when the number of coins reaches a set number value. The coin detector 56 counts the number of coins paid out by the hopper 55 and transmits the counted number of coins to the payout completion signal circuit 52.

Upon receiving an instruction from the CPU 47, the sound effect control circuit 53 controls a sound signal, which is used to produce a sound from the speakers 15L and 15R and outputs a sound. From the speakers 15L and 15R, for example, a sound is produced to add excitement to the game at an appropriate time after the game starts.

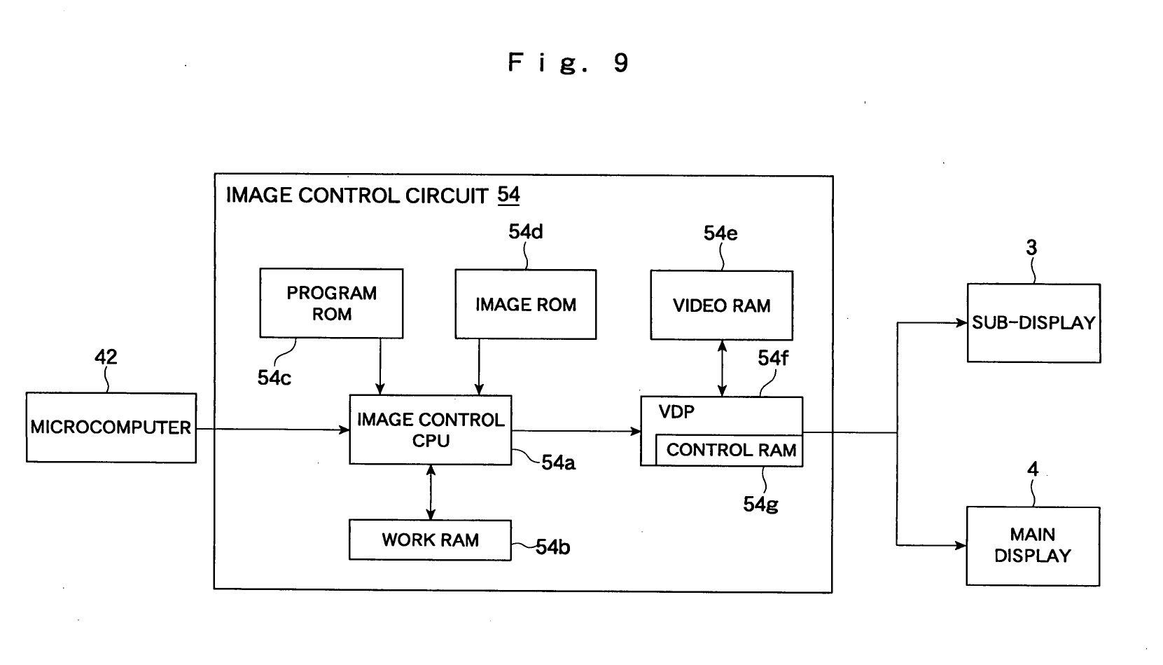

The image control circuit 54 controls an image display on the sub-display 3 and the main display 4. As shown in FIG. 9, the image control circuit 54 includes an image control CPU 54a, a work RAM 54b, a program ROM 54c, an image ROM 54d, a video RAM 54e, and a VDP (Video Display Processor) 54f.

The image control CPU 54a, based on a parameter set by the microcomputer 42, determines an image to be displayed on the sub-display 3 and the main display 4 in accordance with an image control program (regarding the display on the sub-display 3 and the main display 4) preset in the program ROM 54c. The work RAM 54b is configured as a temporary storage unit to be used when the image control CPU 54a executes the image control program. The program ROM 54c stores the image control program, various selection tables, and the like. The image ROM 54d stores dot data for forming an image. The video RAM 54e is configured as a temporary storage unit used for the VDP 54f to form an image. The VDP 54f, including a control RAM 54g, forms images responsive to the display contents of the sub-display 3 and the main display 4 which have been determined by the image control CPU 54a, and outputs and displays the formed images to the sub-display 3 and the main display 4.

Connected to the control board 41 are an IC chip reader/writer 12c, a reel drive unit 57, and a touch panel 58.

The IC chip reader/writer 12c, which is the reading unit of the invention and has a head (not shown), is adapted to communicate with an IC chip 74 of a FIG. 70A, 70B, in proximity to the IC chip 74, via the head by an RFID (Radio Frequency Identification), and thus read a to-be-described figure ID from the IC chip 74.

The reel drive unit 57 includes a reel position detection circuit 59 for detecting the position of the reels 5L, 5C, and 5R and a motor drive circuit 60 for transmitting drive signals to motors M1, M2, AND M3 which rotate the reels 5L, 5C, and SR. Upon receiving the drive signals from this motor drive circuit 60, the motors M1, M2, AND M3 are activated to rotate the reels 5L, 5C, and 5R, respectively.

The touch panel 58, which is the rate selection unit of the invention, is provided so as to cover the surface of the protective glass 32 on the front side of the main display 4. The touch panel 58 detects a position (touch position) thereof which a finger of the player or any other contact body has touched, and transmits, to the CPU 47, corresponding input information, which corresponds to the touch position of a player's finger or the like. For example, the touch panel 58 transmits, to the CPU 47, input information corresponding to the touch position of a player's finger or the like as information for specifying a set rate among rates belonging to a rate group displayed on the main display.

Additionally, the control board 41 is connected with the coin insertion sensor 7a, the bill insertion sensor 8a, the SPIN switch 9, the 1BET switch 10, and the MAXBET switch 11, and adapted to receive signals therefrom.

Configuration of Figure

The configuration of the FIGS. 70A and 70B will now be described. FIGS. 10A and 10B are exploded perspective views of the FIGS. 70A and 70B, respectively, wherein FIG. 10A shows the FIG. 70A representing a high pay rate (henceforth called a high rate) and FIG. 10B shows the FIG. 70B representing a low pay rate (henceforth called a low rate).

The FIGS. 70A and 70B, which are the gaming articles of the invention, each include the pedestal 71 and a figure body 72 representing the type of rate.

The pedestal 71, having a size corresponding to the depression of the pedestal setting portion 12a, is formed into a hollow, thick disk-like shape. The pedestal 71, including a hollow cylindrical pedestal body 73 having a closed top portion 73a and the IC chip 74, is configured to have the IC chip 74 fixedly fitted in the open end portion of the pedestal body 73. In addition, the pedestal 71 has a projection 73b in the approximate center of the top portion 73a of the pedestal body 73. The IC chip 74 stores a figure ID corresponding to the figure body 72.

The figure ID is unique to each figure so as to be able to distinguish one figure from another. Additionally, the figure ID contains the rate type information of the invention so that the FIGS. 70A and 70B, differing in type, can be distinguished from one another. For example, the figure ID of the FIG. 70A contains “A001”, “A002”, “A003”, or the like, and the figure ID of the FIG. 70B contains “B001”, “B002”, “B003”, or the like. The first one digit code indicates the rate type information, and the last three digits indicate a code for identifying a figure. This rate type information A or B indicates the type of rate (the high rate or the low rate), as will be described in detail later.

The figure body 72 includes a leveling pad 75 the bottom of which has a recess 75a corresponding to the projection 73b and the top of which creates a dome shape. Therefore, the figure body 72 is fixed to the top portion 73a of the pedestal 71 by fitting the projection 73b of the pedestal body 73 in the recess 75a.

In addition, the figure body 72, formed together with the top of the leveling pad 75, includes a model portion 76a, 76b. The model portion 76a, 76b, having a three-dimensional shape, is adapted, when set on the figure setting unit 12, such as to impress its existence upon the player and people around him/her, and such as to be capable of making them recognize the entire body of the FIG. 70A, 70B. Specifically, the model portion 76a represents a limousine (luxurious sedan) type automobile which is generally regarded as being expensive, and the appearance thereof enables the player and people around him/her to recognize or suggest a high price. Therefore, the rate type information A stored in the IC chip 74 of the FIG. 70A indicates the high rate in response to the appearance of this model portion 76a. In contrast, the model portion 76b, represents a compact car which is generally regarded as being inexpensive, and the appearance thereof enables the player and people around him/her to recognize or suggest a low price. Therefore, the rate type information B stored in the IC chip 74 of the FIG. 70B indicates the low rate in response to the appearance of this model portion 76b.

### Operational content of Slot Machine

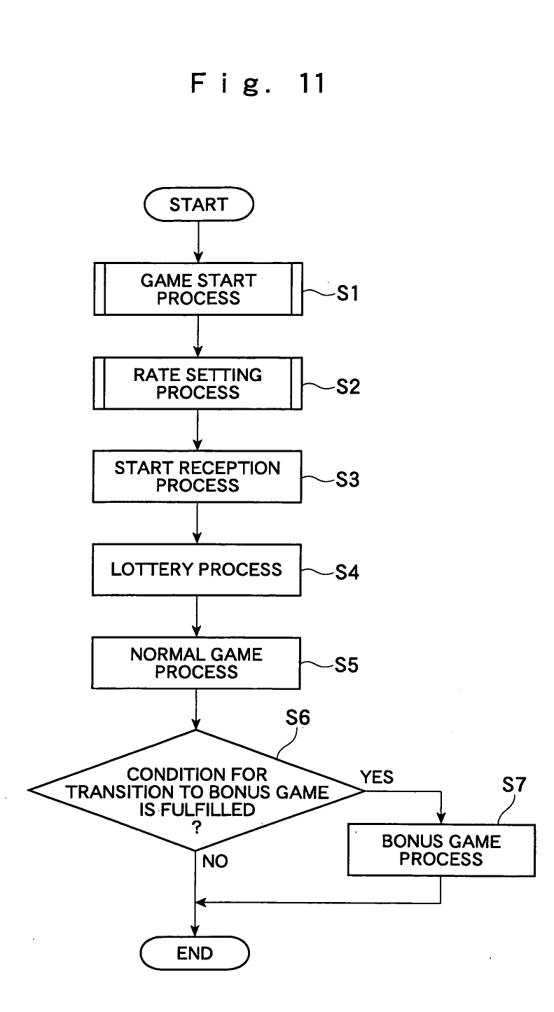

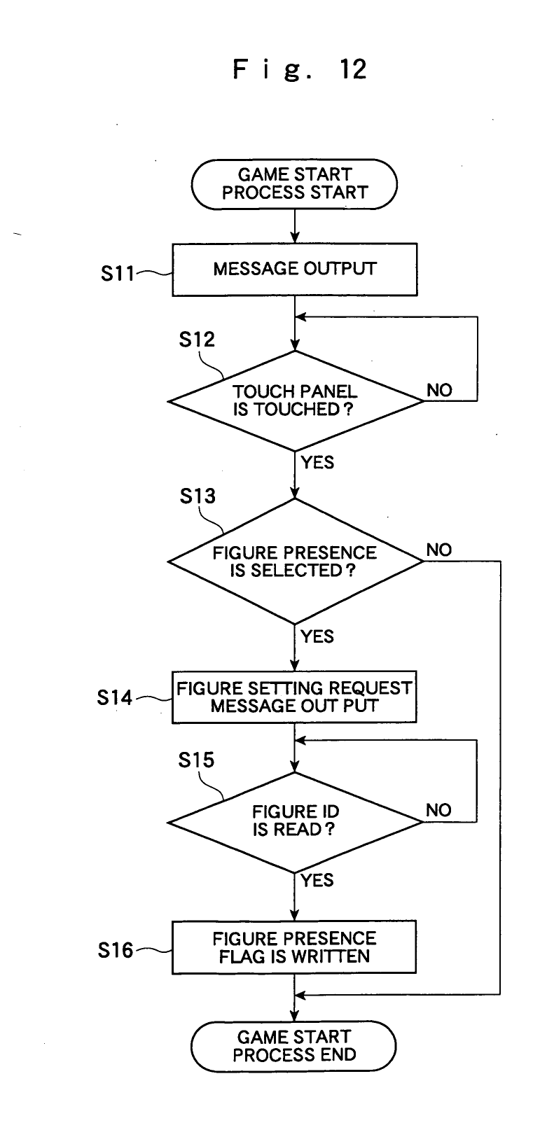

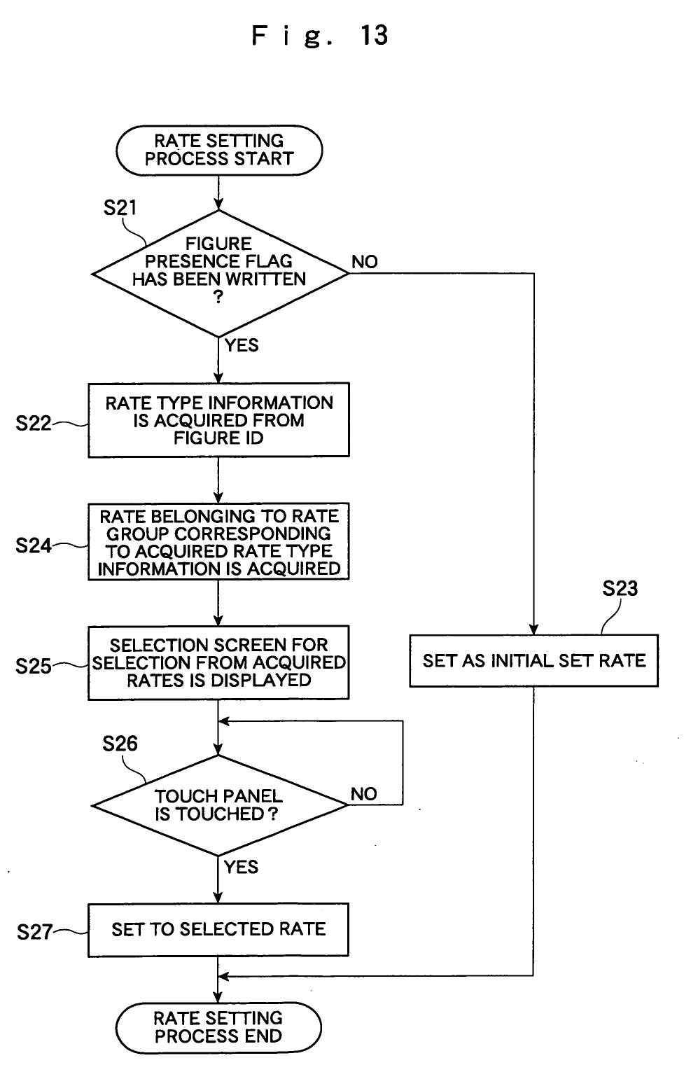

The operational content of the slot machine 1A having the aforementioned configuration will now be described with reference to flowcharts shown in FIGS. 11 to 13. FIG. 11 is a flowchart showing the operational procedure of a main process from the start to the end of the game on the slot machine 1A. FIG. 12 is a flowchart showing the operational procedure of a game start process shown in FIG. 11. FIG. 13 is a flowchart showing the operational procedure of a rate setting process shown in FIG. 11. In FIGS. 11 to 13, the term step is abbreviated as “S”.

The slot machine 1A of this embodiment has a special gaming mode in addition to a normal gaming mode for performing a normal game. The slot machine 1A is adapted such that the normal game is performed when the gaming mode is in the normal gaming mode, while a bonus game which provides the player with a greater advantage is performed when the gaming mode makes a transition to the special gaming mode.

In the slot machine 1A, as shown in FIG. 11, when the main process is started, the process moves to step 1 to perform the game start process, and in the subsequent step 2, the rate setting process is performed. Subsequently, in steps 3 to 7, a start reception process, a lottery process, a normal game process, a determination as to a transition condition for making a transition to the bonus game, and a bonus game process are performed in sequence, thus bringing the main process to an end. The details of each block will described below.

First, when the process moves to step 1 to start the game start process, the process moves to step 11 shown in FIG. 12. In step 11, the CPU 47 performs a message output process and instructs the image control circuit 54 to display on the main display 4 a figure presence/absence selection screen which is used to determine whether or not the game is to be played using the FIG. 70A, 70B. In the subsequent step 12, the process waits until the touch panel 58 is touched. If the touch panel 58 has been touched, the process moves to step 13 to determine whether or not the figure presence has been selected in step 12. At this point, if the figure presence has been selected, the process moves to step 14, and if not, the game start process is brought to an end.

When the process moves to step 14, a FIG. 70A, 70B setting request message output process is performed. That is, the CPU 47 instructs the image control circuit 54 to display on the main display 4 a message which requires the player to set the FIG. 70A, 70B on the figure setting unit 12 to have the figure ID read. In the subsequent step 15, the process waits until the IC chip reader/writer 12c finishes reading the figure ID. At this point, when the player sets the FIG. 70A, 70B on the figure setting unit 12 in accordance with the message displayed, the IC chip reader/writer 12c reads the figure ID stored in the IC chip 74 of the FIG. 70A, 70B and sends it to the CPU 47. In response to the input of the figure ID, the process moves to step 16. In step 16, predetermined data (in this embodiment, “1”) is written to a figure presence flag indicating that the figure ID has been read (the figure has been set) by the figure setting unit 12, and the game start process is then brought to an end.

Next, the process moves to step 2, wherein the CPU 47 operates as the rate setting unit of the invention to perform the rate setting process. When the rate setting process is started, as shown in FIG. 13, the process moves to step 21. In step 21, from the result of the game start process, it is determined whether or not the predetermined data has been written to the figure presence flag, and in response to the determination result, the process is branched into step 22 or step 23. That is, if the figure presence flag has been written, the process moves to step 22, and if not, the process moves to step 23 to set the set rate of the slot machine 1A to the initial set rate (¢5), and the process is then brought to an end. On the other hand, the process moves to step 22 to acquire the rate type information A, B contained in the figure ID read in step 15 of Fig. 12. The process moves to step 24 to refer to the first rate table shown in FIG. 8 and thus acquire three rates belonging to a rate group corresponding to the rate type information A, B acquired in step 22.

The process then moves to step 25, wherein the CPU 47 instructs the image control circuit 54 to display on the main display 4, which is the display unit of the invention, a rate selection screen with which the player selects any one from the three rates acquired in step 24. That is, when the rate type information acquired in step 22 is “A”, the three rates “$1, $5, $10” and an image containing a message for prompting the player to select any one thereof are displayed on the main display 4. In contrast, when the rate type information acquired in step 22 is “B”, the three rates “¢5, ¢25, ¢50” and an image containing a message for prompting the player to select any one thereof are displayed on the main display 4. In the subsequent step 26, the process waits until the player has touched a portion of the touch panel 58 corresponding to any one of the three rates displayed in step 25. If the corresponding input information is received, it is determined that the touch panel 58 has been touched, and the process thus moves to step 27. In step 27, the rate specified by the corresponding input information is set as the set rate, and the rate setting process is then brought to an end. Specifically, when the player has touched a portion of the touch panel 58 corresponding to $1 out of the three rates “$1, $5, $10” which belong to rate group A and are displayed on the main display 4, the rate $1 is specified from among the rate group and is set as the set rate. When the player has touched a portion of the touch panel 58 corresponding to $5 or $10, similarly, the rate $5 or $10 is specified from among the rate group and is set as the set rate.

Next, the process moves to step 3 to perform the start reception process. That is, the player either inserts a desired number of coins into the coin insertion slot 7 or operates the 1BET switch 10 or the MAXBET switch 11 if any credits are remaining. Subsequently, the operation of the SPIN switch 9 (which operation is henceforth called a “start operation”) is performed. By this start operation, a start signal is inputted from the SPIN switch 9 to the CPU 47.

Next, the process moves to step 4 to perform the lottery process. In this lottery process, upon receiving the start signal, the CPU 47 operates to determine a symbol (not shown) to be stopped on the pay line L1 (a stop symbol) for each of the reels 5L, 5C, and 5R. By referring to a winning combination determination table stored in the ROM 49, the CPU 47 determines whether the game is won or not in response to the combination of stop symbols on the reels 5L, 5C, and 5R. Subsequently, by referring to a state table stored in the ROM 49, the CPU 47 determines a winning state if the game is won (the “winning state” is also called a “winning combination”). The state table is used to determine the state in which the game is won (winning state) and registers the set rates set in the aforementioned rate setting process and awards corresponding to the winning states. Besides, this lottery process is adapted such that the bonus game is performed when a specific symbol appears on the pay line L1.

Next, in step 5, when the normal game process is started, a slot game is started. At this point, the CPU 47 instructs the motor drive circuit 60 to operate the motors M1, M2, AND M3. Then, the reels 5L, 5C, and 5R rotate for a fixed time. Thereafter, the CPU 47 instructs the motor drive circuit 60 to stop the reels 5L, 5C, and 5R so that the stop symbols determined by the lottery process of step 4 appear on the pay line L1. At this point, if the game is determined to have been won by the lottery process of step 4, the CPU 47 instructs the hopper drive circuit 51 to drive the hopper 55 to pay out a number of coins equivalent to the award corresponding to the winning state.

Next, in step 6, it is determined whether the transition condition for making a transition to the bonus game is fulfilled or not by the lottery process of step 4. If the transition condition is not fulfilled, the main process is brought to an end. If the transition condition is fulfilled, the process moves to step 7 to perform the bonus game process, and the main process is thereafter brought to an end. At this point, a slot game similar to the aforementioned one may be adopted as the bonus game, but any other game differing from the slot game may also be adopted, such as a card game which is played by displaying on the main display 4 card images representing playing cards.

As described above, the slot machine 1A of this embodiment employs the expensive-looking FIG. 70A of high rate and the inexpensive-looking FIG. 70B of low rate. This enables even people around players to easily distinguish a player playing the game at the high rate from a player playing the game at the low rate by the appearance of the FIG. 70A, 70B. Accordingly, in particular, it follows that the player playing at the high rate can draw the attention of people around him/her to the fact that he/she is playing the game at the high rate. As a result thereof, the desire to attract another's attention can be fulfilled, and the game can be rendered interesting.

Additionally, in the slot machine 1A, in the rate setting process, the set rate is set to the initial set rate when the figure presence flag has not been written. Therefore, the game can be played even when the IC chip reader/writer 12c has not read the rate type information A, B.

Furthermore, the slot machine 1A is adapted such that the player can select a rate by operating the touch panel 58.

### Second Embodiment

A slot machine 1B of a second embodiment has the same configuration as the aforementioned slot machine 1A of the first embodiment, but differs from the slot machine 1A in the operation of the IC chip reader/writer 12 and in that the ROM 49 stores a second rate table. In addition, the slot machine 1B differs from the slot machine 1A in that the IC chip 74 stores figure use history information in addition to the figure ID. Furthermore, the slot machine 1B differs from the aforementioned slot machine 1A in its internal process. A description will hereafter be given focusing on these differences, and redundant description will thus be omitted.

### Internal Configuration of Slot Machine

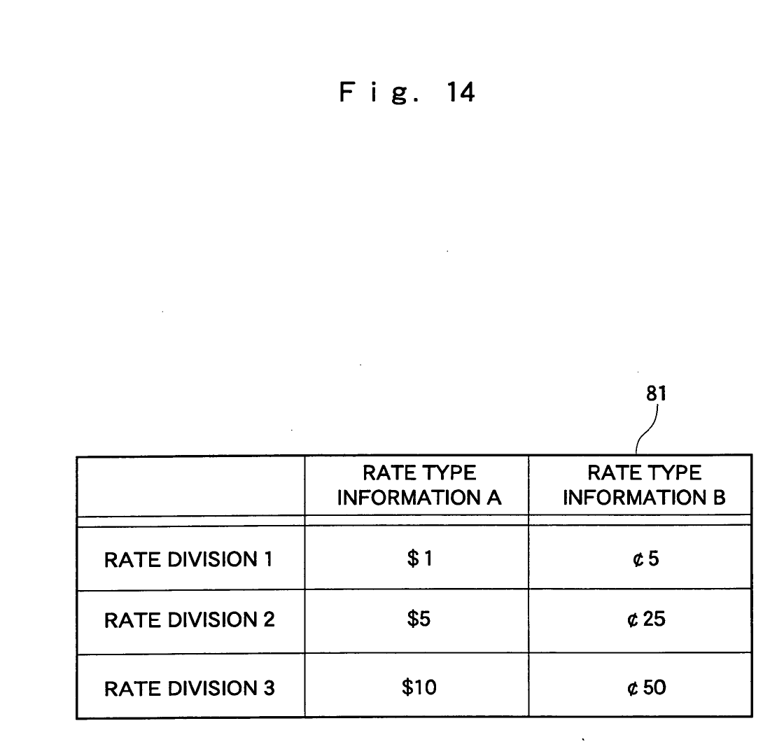

The slot machine 1B has the same internal configuration as the first slot machine 1A of the first embodiment and includes the ROM 49 on the control board 41 (see FIG. 7). The ROM 49 has the function of serving as the rate storage unit of the invention. That is, the ROM 49 stores the to-be-described second rate table (see FIG. 14) 81 in which the combinations of “rate division 1” to “rate division 3” and the rate type information A, B are related to the rates of these combinations. This second rate table 81 contains “rate division 1” to “rate division 3” which are divisions of use history information classified by predetermined thresholds, wherein these “rate division 1” to “rate division 3” are related to rates corresponding to the rate type information A, B. Specifically, when the rate type information is “A” and falls within the “rate division 1”, the rate is $1. When the rate type information is “A” and falls within the “rate division 2”, the rate is $5. And, when the rate type information is “A” and falls within the “rate division 3”, the rate is $10. Besides, when the rate type information is “B” and falls within the “rate division 1”, the rate is ¢5. When the rate type information is “B” and falls within the “rate division 2”, the rate is ¢25. And, when the rate type information is “B” and falls within the “rate division 3”, the rate is ¢50. In this way, the rates corresponding to the “rate division 1” to the “rate division 3” are $1, $5, and $10 (or ¢5, ¢25, and ¢50), respectively, and the rate becomes higher in stages as the use frequency increases.

The IC chip reader/writer 12c is connected to the control board 41. The IC chip reader/writer 12c, which is the reading unit of the invention, is adapted to read the figure ID and the use history information (the details of which will be described later), indicative of the use history of the FIGS. 70A and 70B, from the IC chip 74 via the head (not shown). The IC chip reader/writer 12c is also adapted to write the use history information to the IC chip 74.

### Configuration of Figure

In the FIG. 70A, 70B, the IC chip 74 stores the figure ID containing the rate type information and further stores the use history information such as the use frequency and use time of the figure. This use history information is read/written by the IC chip reader/writer 12c with the FIG. 70A, 70B set on the figure setting unit 12. Here, the use frequency of the figure refers to a cumulative number of times that the main process of the slot machine 1 B has been performed with the FIG. 70A, 70B set on the figure setting unit 12. The use time of the figure refers to a cumulative time for which the FIG. 70A, 70B has been set on the figure setting unit 12. In the initial stage where the figure has not yet been used, “0” is stored in the IC chip 74 as the use history information.

### Operational content of Slot Machine

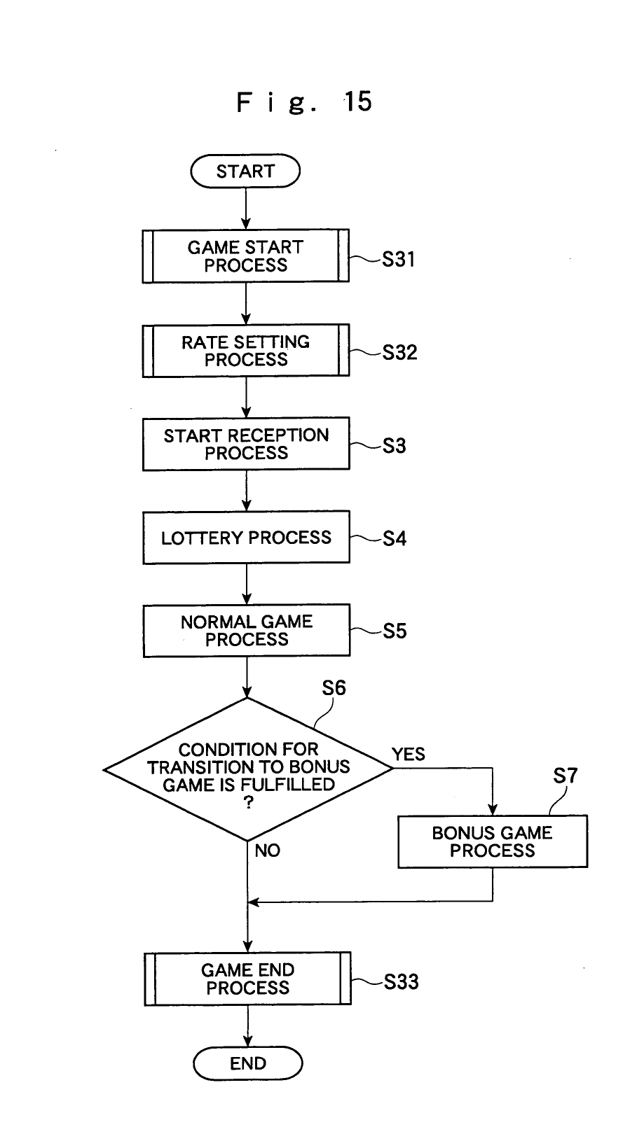

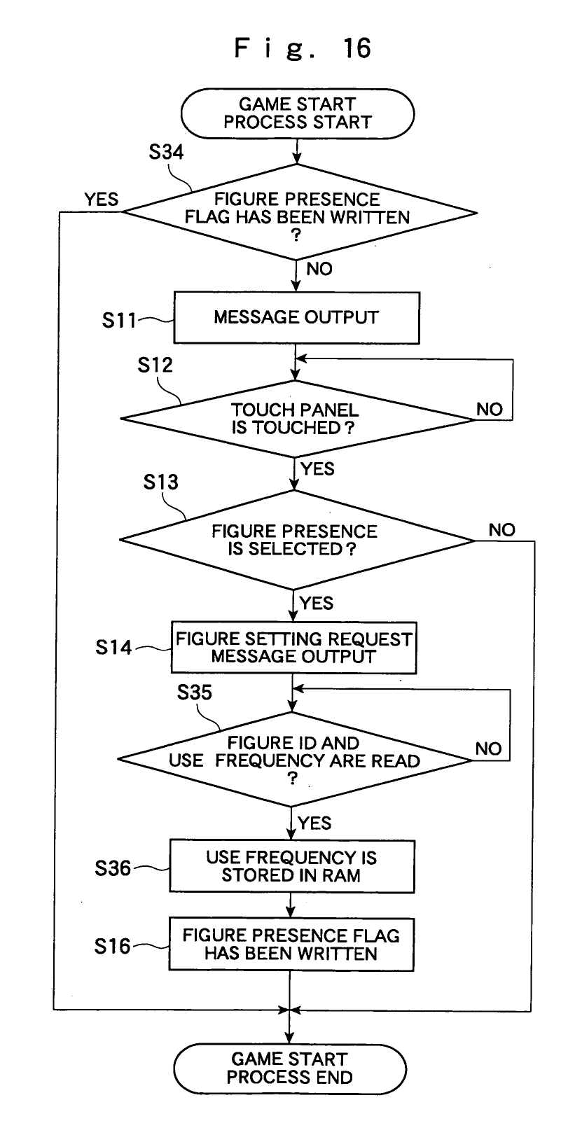

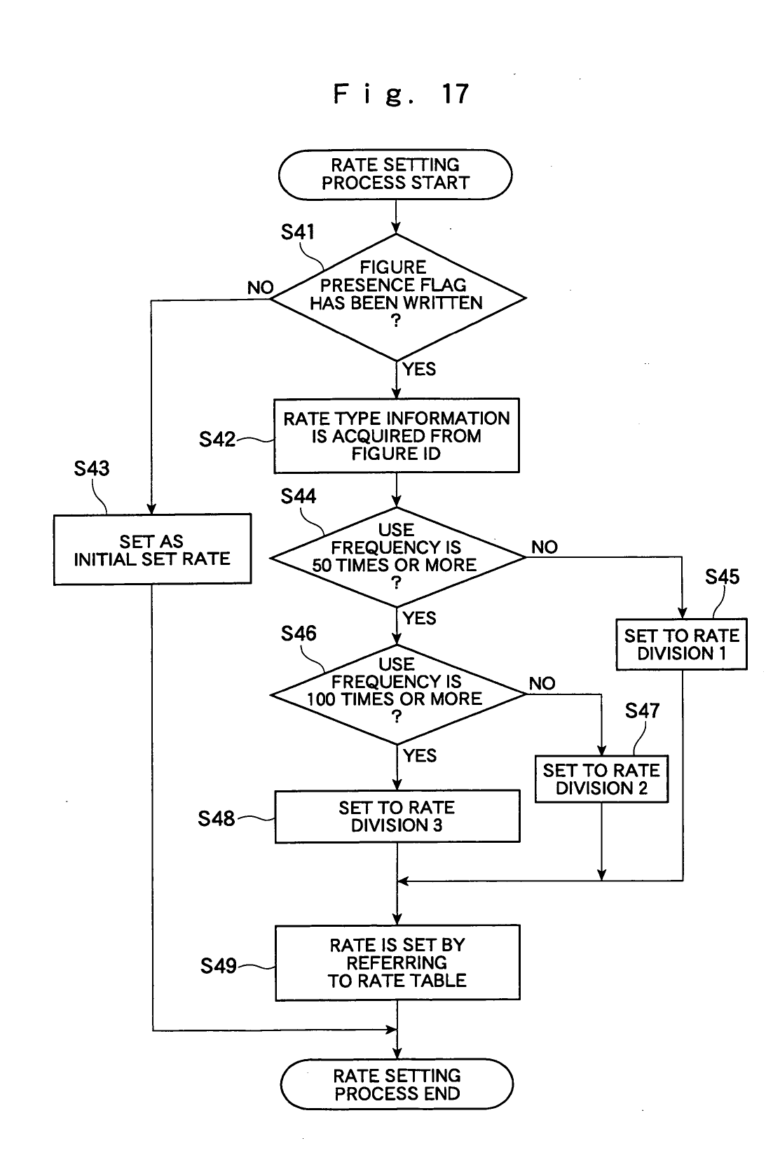

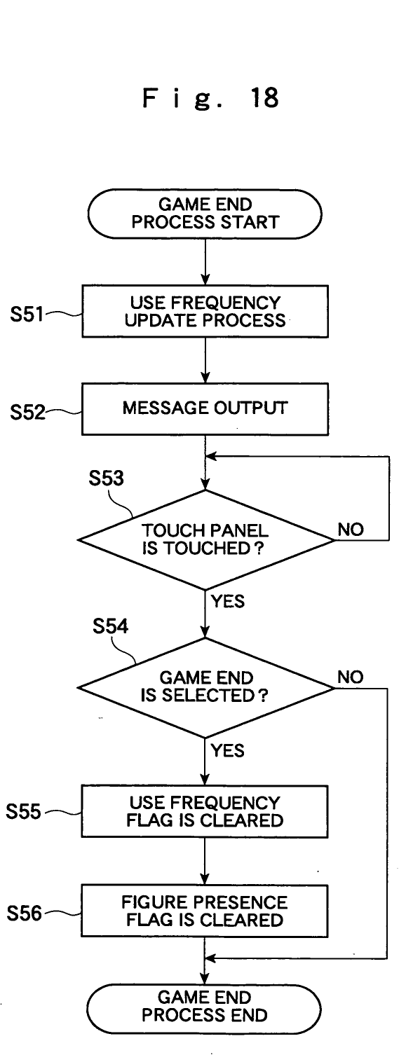

The operational content of the slot machine 1B having the aforementioned configuration will now be described with reference to FIGS. 14 to 18. FIG. 14 is a diagram showing the content of the second rate table. FIG. 15 is a flowchart showing the operational procedure of a main process from the start to the end of the game on the slot machine 1B. FIG. 16 is a flowchart showing the operational procedure of a game start process shown in FIG. 15. FIG. 17 is a flowchart showing the operational procedure of a rate setting process shown in FIG. 15. And, FIG. 18 is a flowchart showing the operational procedure of a game end process shown in FIG. 15. In FIGS. 15 to 18, the term step is abbreviated as “S”.

The slot machine 1B of this embodiment is adapted such that the rate is set in response to the use history information stored in the FIG. 70A, 70B. In this embodiment, the case in which the use history information refers to the use frequency of the figure will be described as an example. However, the same process is performed in the case where the use history information refers to the use time of the figure.

In the slot machine 1B, as shown in FIG. 15, when the main process is started, the process moves on to step 31 and performs the game start process, and in the subsequent step 32, the rate setting process is performed. Subsequently, in steps 3 to 6, the same processes as those in the first embodiment are performed. In step 6, if the transition condition for making a transition to the bonus game is fulfilled, the process moves to step 7 to perform a bonus game, and the process thereafter moves to step 33. If the transition condition is not fulfilled, the process moves to step 33 without performing the bonus game. In step 33, the game end process is performed, and the main process is thereafter brought to an end. The details of each block will be described below.

First, when the process moves to step 31 to start the game start process, the process moves to step 34 shown in FIG. 16 to determine whether or not the figure presence flag has been written. That is, when the game is continued with the FIG. 70A, 70B being set, the figure presence flag has been written, so that the processes in steps 11 to 16 are skipped, and the game start process is brought to an end. On the other hand, when a new round of the game is played by setting the FIG. 70A, 70B, the figure presence flag has not been written, and the process therefore moves to the subsequent steps 11 to 14, thus performing the same processes as those in the first embodiment. In the subsequent step 35, the process waits until the IC chip reader/writer 12c finishes reading the figure ID and the use frequency of the figure. That is, the player sets the FIG. 70A, 70B on the figure setting unit 12 in accordance with the message displayed. Thereafter, the process waits until the figure ID and the use frequency, stored in the IC chip 74 of the FIG. 70A, 70B, and read by the IC chip reader/writer 12c, are received. Upon receiving the figure ID and the use frequency, the process moves to step 36 to temporarily store the read use frequency in the RAM 48. Then, the process moves to step 16 to write to the figure presence flag in the same manner as in the first embodiment, and the game start process is then brought to an end.

Next, the process moves to step 32, wherein the CPU 47 operates as the rate setting unit of the invention to perform the rate setting process. When the rate setting process is started, as shown in FIG. 17, the process moves to step 41. In step 41, from the result of the game start process, it is determined whether or not the figure presence flag has been written, and in response to the determination result, the process is branched into step 42 or step 43. That is, if the figure presence flag has been written, the process moves to step 42, and if not, the process moves to step 43 to set the set rate of the slot machine 1B to the initial set rate (¢5), and the process is then brought to an end. When the process moves to step 42, the rate type information A, B contained in the figure ID read in step 35 of FIG. 16 is acquired. In the subsequent step 44, it is determined whether or not the use frequency stored in the RAM 48 in step 35 of FIG. 16 (which is the use frequency read from the figure) is 50 times or more. If it is determined that the use frequency is not 50 times or more, the process moves to step 45 to set this use frequency in the “rate division 1” which is the first division of the use frequency. Conversely, if it is determined that the use frequency is 50 times or more, the process moves to step 46 to determine whether or not the use frequency is 100 times or more. If it is determined that the use frequency is not 100 times or more, the process moves to step 47 to set this use frequency in the “rate division 2” which is the second division of the use frequency. Conversely, if the use frequency is 100 times or more, the process moves to step 48 to set this use frequency in the “rate division 3” which is the third division of the use frequency.

In steps 45, 47, and 48, the use frequency is thus set in any one of the “rate division 1” to the “rate division 3”, and the process thereafter moves to step 49. In step 49, the rate type information A, B and the “rate division 1” to the “rate division 3” are written to search keys, a search is performed in the second rate table 81 (stored in the ROM 49), and the corresponding rates are set as the set rates. Specifically, when the figure rate type information contained in the figure ID read in step 34 of FIG. 16 is “A” and the use frequency of the figure, stored in the RAM 48, is less than 50 times, the rate division is “1”, so that $1 is set as the set rate. When the use frequency is 50 times or more and less than 100 times, the rate division is “2”, so that $5 is set as the set rate. And, when the use frequency is 100 times or more, the rate division is “3”, so that $10 is set as the set rate. Besides, when the rate type information read in step 35 of FIG. 16 is “B”, as with the aforementioned case in which the rate type information is “A”, any one of ¢5, ¢25, and ¢50 is set as the set rate according to the rate division.

Thereafter, the process moves to step 33 to perform the game end process. When the game end process is started, the process moves to step 51 shown in FIG. 18. In step 51, after the use frequency stored in the RAM 48 is read, the use frequency is updated by adding “1”thereto, and the updated use frequency is stored again in the RAM 48. In the subsequent step 52, the CPU 47 instructs the image control circuit 54 to display on the main display 4 a message, which makes a request to the player to select whether to end the game or not, and a selection screen for making the selection. In the subsequent step 53, the process waits until the player has touched the touch panel 58. If the touch panel 58 has been touched, the process moves to step 54, wherein it is determined in step 54 whether game end has been selected or not. If game end has been selected, the process moves to step 55, and if not, the game end process is brought to an end.

In step 55, the CPU 47 is operated to read the use frequency stored in the RAM 48, thus performing a write process in which the read use frequency is written to the IC chip 74 of the FIG. 70A, 70B by the IC chip reader/writer 12c. In the subsequent step 56, predetermined data (in this embodiment, “0”) is written to the figure presence flag (flag is cleared), and the game end process is then brought to an end.

As described above, similar to the slot machine 1A of the first embodiment, the slot machine 1B of this embodiment employs the expensive-looking FIG. 70A of high rate and the inexpensive-looking FIG. 70B of low rate. This enables even people around a player to easily distinguish a player playing the game at the high rate from a player playing the game at the low rate by the appearance of the FIG. 70A, 70B. Accordingly, in particular, it follows that the player playing at the high rate can draw the attention of people around him/her to the fact that he/she is playing the game at the high rate. As a result thereof, the desire to attract another's attention can be fulfilled, and the game can be rendered interesting.

Additionally, similar to the slot machine 1A of the first embodiment, in the slot machine 1B, in the rate setting process, the set rate is set as the initial set rate when the figure presence flag has not been written. Therefore, the game can be played even when the IC chip reader/writer 12c has not read the rate type information A, B.

Furthermore, in the slot machine 1B, in addition to the rate type information A, B, the rate is set in response to the use history information, such as the use frequency or the use time of the FIG. 70A, 70B. Therefore, an appropriate rate corresponding to the use history of the FIG. 70A, 70B can be set as the set rate.

### Third Embodiment

A slot machine 1C of a third embodiment has the same internal process as the aforementioned slot machine 1A or 1B of the first or second embodiment, while the configuration of the slot machine 1C is different from that of the slot machine 1A or 1B in that the slot machine 1C is a so-called video slot machine. A description will hereafter be given, particularly focusing on the difference in configuration, and redundant description will thus be omitted.

### Overall Configuration of Slot Machine

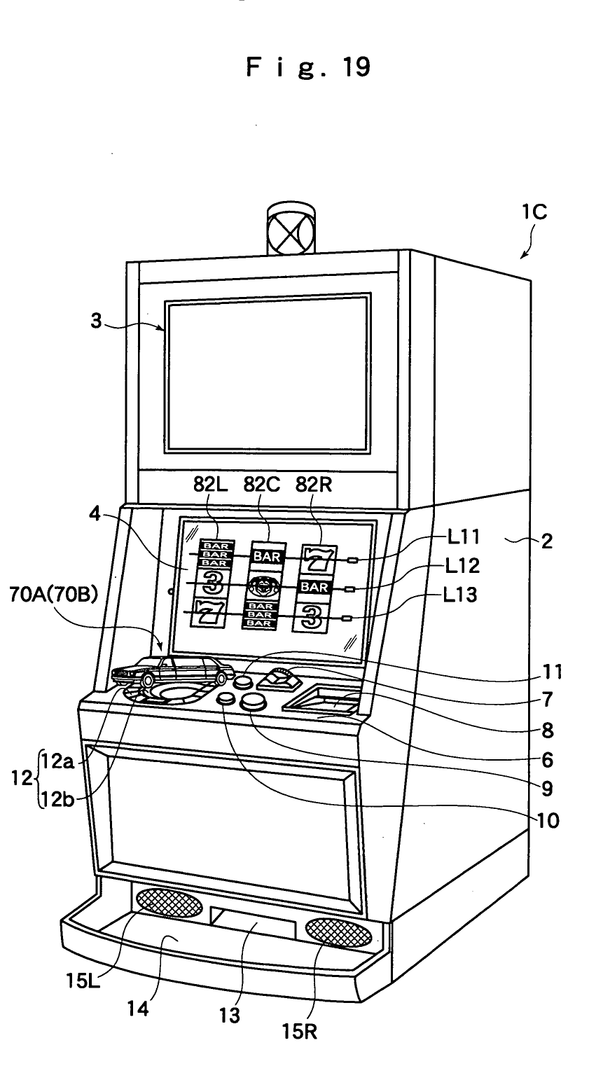

FIG. 19 is a perspective view showing the overall configuration of the slot machine 1C. The slot machine 1C, which is the gaming machine of the invention, includes a main display 4 for displaying a game image for use in a game. On the main display 4 is displayed a variable display image (reel image) which shows a plurality of (three) mechanical reels each having a plurality of symbols arranged thereon, and which resembles the reels rotating. This slot machine 1C provides a video slot machine capable of performing a slot game in which whether a win is obtained or not is determined by the combination of symbols obtained when the reels displayed on the main display 4 (reels displayed using images are also called “pseudo-reels”) are stopped.

The main display 4 is adapted to display variable display windows 82L, 82C, and 82R arranged in three vertical columns. In addition, the main display 4 is adapted, in both a normal gaming mode (a normal game) and a special gaming mode (a bonus game), such that a variable display image, resembling the plurality of symbols scrolling downward, is displayed in each of the variable display windows 82L, 82C, and 82R. Furthermore, the main display 4 is adapted, when its variable display is stopped, such that three symbols are displayed, vertically arranged, in each of the variable display windows 82L, 82C, and 82R. An effect for increasing a player's interest and information used for the player to proceed with the game to his/her advantage are displayed in the region of the main display 4 outside the variable display windows 82L, 82C, and 82R.

As shown in FIG. 19, the main display 4 is adapted such that three horizontally extending pay lines L11 to L13 are displayed thereon in response to these variable display windows 82L, 82C, and 82R. In FIG. 19 shows the state in which symbols are stopped on these pay lines L11 to L13. In addition to the pay lines L11 to L13, two more pay lines may be diagonally displayed.

### Internal Configuration of Slot Machine

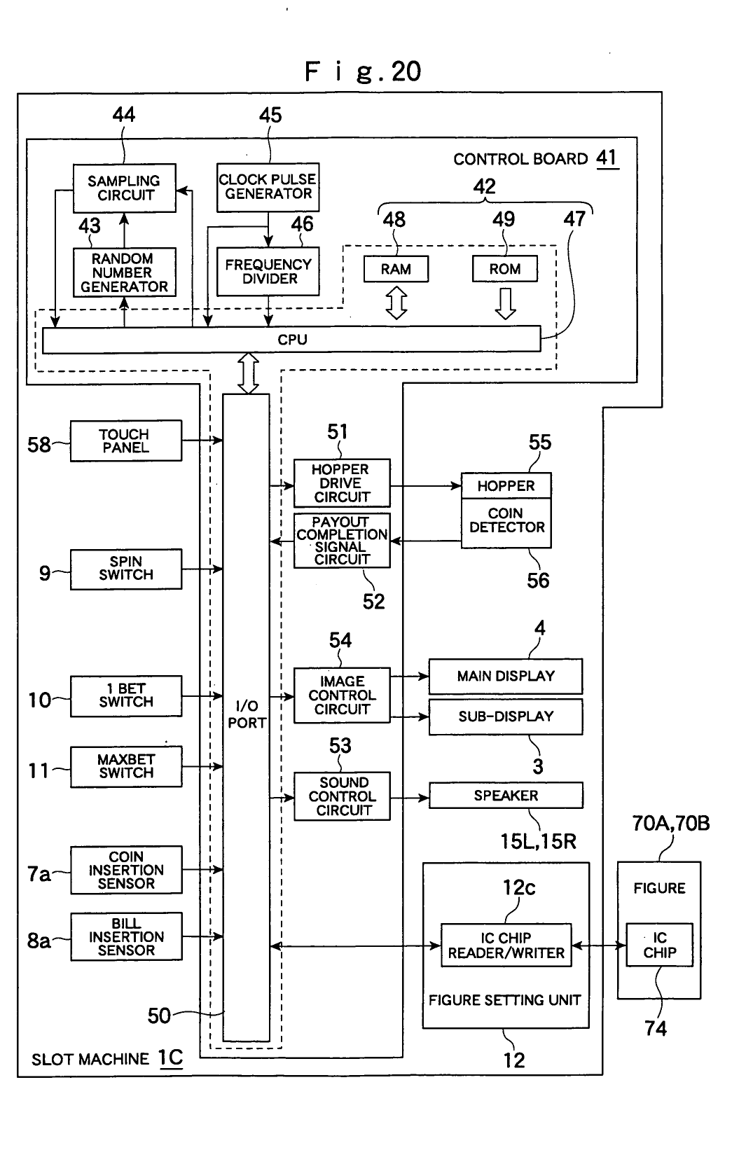

FIG. 20 is a block diagram of the slot machine 1C of the third embodiment, showing its main internal configuration. The slot machine 1C includes an image control circuit 54 on a control board 41. This image control circuit 54 controls the image display of a sub-display 3 and the main display 4 to display various images, such as a plurality of symbol variable display images, on the main display 4. In addition, similar to the first embodiment, the image control circuit 54 includes an image ROM 54d (see FIG. 8). This image ROM 54d stores dot data for forming images, and in this embodiment, the dot data includes symbol image data for displaying symbols to be used in the normal game and the bonus game.

### Operational content of Slot Machine

The slot machine 1C of this embodiment has the same operational content as the slot machine 1A or 1B of the first or second embodiment. That is, when the slot machine 1C performs the same operation as the slot machine 1A of the first embodiment, a FIG. 70A or 70B can be used to play at a high rate or a low rate, and a rate which the player has selected, by touching a touch panel 58 from a plurality of rates displayed on the main display 4, is set as a set rate. In contrast, when the slot machine 1C performs the same operation as the slot machine 1B of the second embodiment, the FIG. 70A or 70B can be used to play at the high rate or the low rate, and a “rate division 1” to a “rate division 3”, which are the divisions of rate type information A, B and use history information, are written to search keys, a search is made in a second rate table 81 (see FIG. 14), and the corresponding rate is set as the set rate.

As described above, the slot machine 1C of this embodiment exerts the same operation/working-effect as the slot machine 1A or 1B of the first or second embodiment.

### Fourth Embodiment

In a fourth embodiment, the following gaming system 100 will be described as an example in which the invention is applied to a gaming system including a plurality of gaming machines and a server.

### Overall Configuration of Gaming System

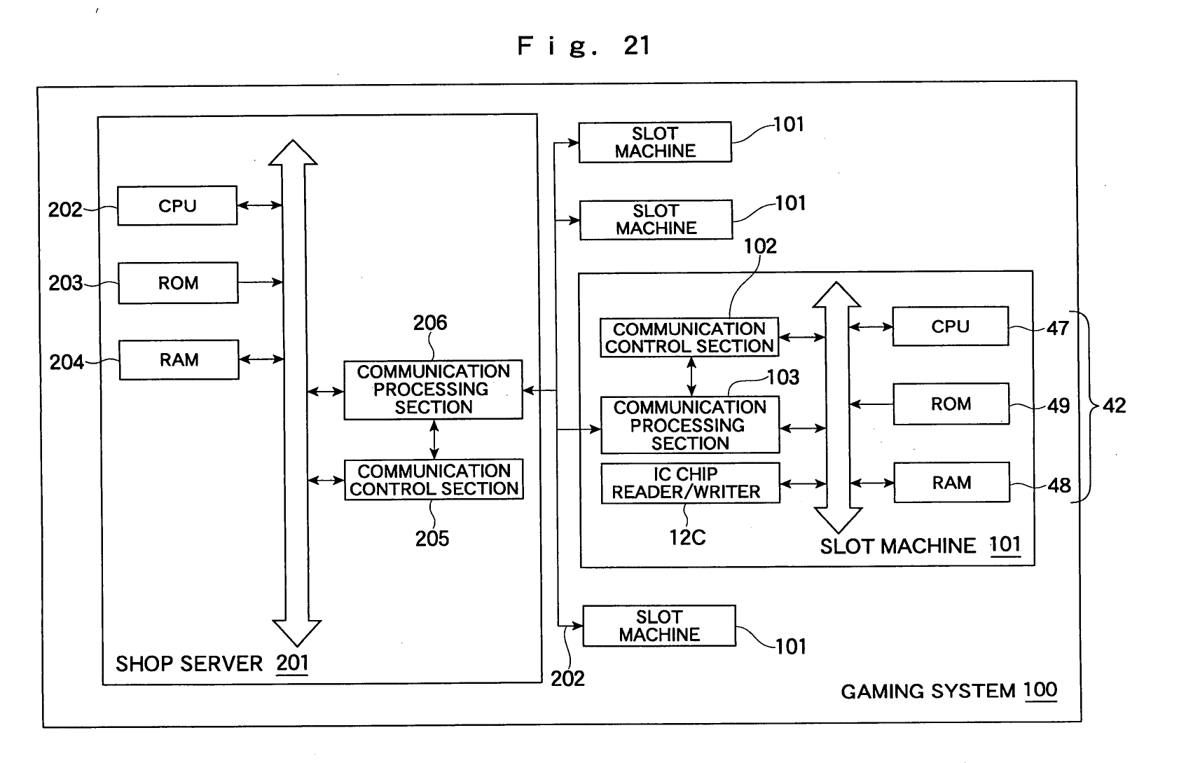

FIG. 21 is a system configuration diagram of the gaming system 100 including a plurality of slot machines 101 and a shop server 201. The gaming system 100 includes the shop server 201 installed in a game shop and the plurality of (in this embodiment, four) slot machines 101 communicably connected to the shop server 201 via dedicated lines 202. In the gaming system 100, each slot machine 101 and the shop server 201, having a dedicated connection to one another, form a LAN (Local Area Network).

### Configuration of Slot Machine

The slot machine 101, which is the gaming machine of the invention, as schematically shown in FIG. 21, includes a microcomputer 42 made up of a CPU 47, a RAM 48, and a ROM 49, as well as an IC chip reader/writer 12c, a communication control section 102, and a communication processing section 103. The other configurations of the slot machine 101 are the same as those of the slot machines 1A to IC of the first to third embodiments, wherein a plurality of symbols are variably displayed using mechanical reels or pseudo-reels displayed on a main display 4.

The communication control section 102 of the slot machine 101 operates in accordance with an instruction from the CPU 47 to control the connection and disconnection of a line used to communicate with the shop server 201. The communication processing section 103 operates in accordance with an instruction from the communication control section 102. The communication processing section 103 thus transmits to the shop server 201 a figure ID and use history information (figure data), which have been read by the IC chip reader/writer 12c, via the dedicated line 202, and receives from the shop server 201 information (rate information) containing a rate set by the shop server 201 in response to this figure data.

### Configuration of Shop Server

The shop server 201, which is the server of the invention, as shown in FIG. 21, includes a CPU 202, a ROM 203, a RAM 204, a communication control section 205, and a communication processing section 206. The CPU 202, as it operates, writes data to the RAM 204 in accordance with a program stored in the ROM 203. The communication control section 205 operates the communication processing section 206 in accordance with an instruction from the CPU 202. The shop server 201 receives the figure data from each slot machine 101 via the dedicated lines 202, and transmits, to each slot machine 101, information containing the rate information in response to this figure data.

### Operational contents of Slot Machine and Shop Server

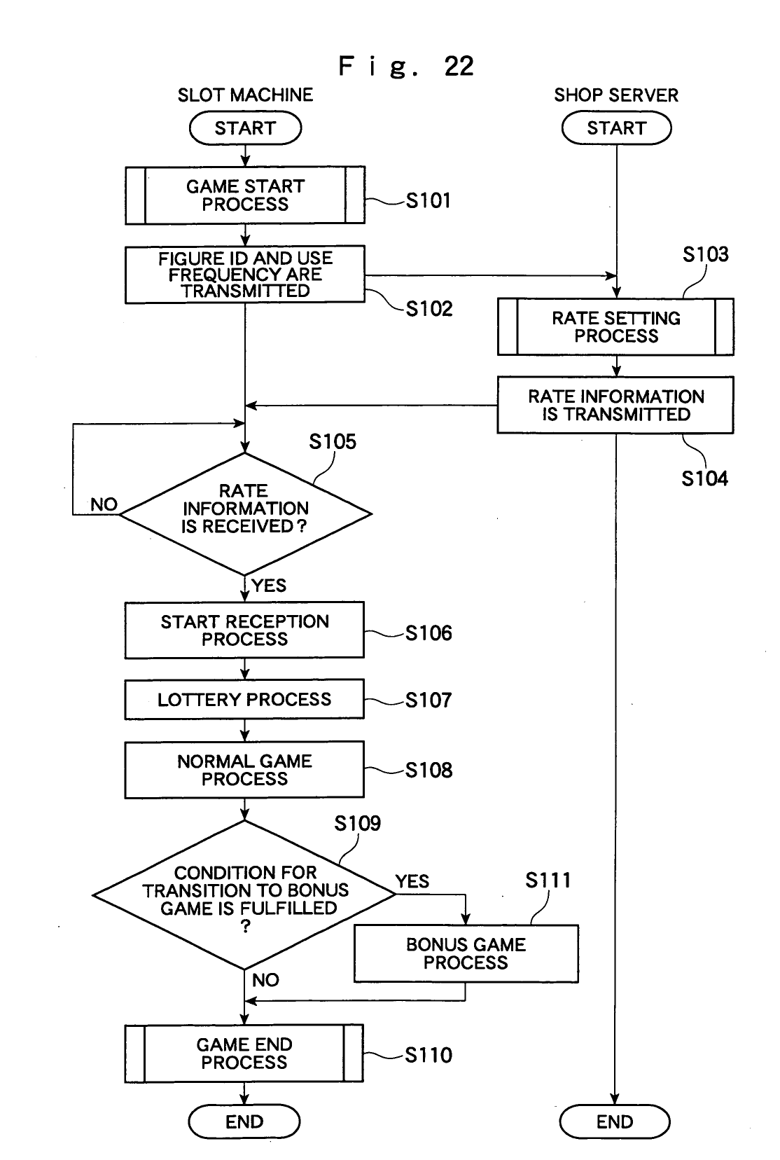

The operational contents of the slot machine 101 and the shop server 201 which have the aforementioned configurations will now be described with reference to FIGS. 16 to 18 and 22. FIG. 22 is a sequence chart showing the operation sequence performed between the slot machine 101 and the shop server 201. In FIG. 22, the term step is abbreviated as “S”.

In slot machine 101, as shown in FIG. 22, when a main process is started, the process moves to step 101 to perform a game start process shown in FIG. 16. Subsequently, the process moves to step 102, wherein the communication control section 102 operates the communication processing section 103 to transmit to the shop server 201 the figure ID and use frequency which have been read in step 35 of FIG. 16.

Then, in the shop server 201, the process moves to step 103 to perform a rate setting process shown in FIG. 17. In the rate setting process, rate type information A, B contained in the figure ID transmitted in step 102 and a “rate division 1” to a “rate division 3” which are the divisions of the use frequency are written to search keys, a search is performed in a second table 81 (see FIG. 14), and the corresponding rate is set as set rate. Subsequently, in step 104, the communication control section 205 operates the communication processing section 206 to transmit the rate information containing the set rate to the slot machine 101.

In the slot machine 101, in step 102, the figure ID and use frequency are transmitted to the shop server 201, and the process thereafter moves to step 105. In step 105, the process is placed on standby until the rate information is received from the shop server 201. When the rate information is received from the shop server 201, the process moves to step 106 to perform a start reception process. In step 107, a lottery process is performed, and thereafter, in step 108, a normal game process is performed with the gaming mode in the normal gaming mode. In the subsequent step 109, in response to the result of the lottery process in step 107, it is determined whether the transition condition for making a transition to the bonus game is fulfilled or not. If the transition condition is not fulfilled, the process moves to step 110, but if the transition condition is fulfilled, the process moves to step 111. In step 111, a bonus game process is performed, and the process thereafter moves to step 110. In step 110, a game end process shown in FIG. 18 is performed, and the main process is thereafter brought to an end.

As described above, similar to the slot machines 1A to 1C of the first to third embodiments, the slot machine 101 of the gaming system 100 according to this embodiment employs the expensive-looking FIG. 70A of high rate and the inexpensive-looking FIG. 70B of low rate. This enables even people around a player to easily distinguish a player playing the game at the high rate from a player playing the game at the low rate by the appearance of the FIG. 70A, 70B. Accordingly, in particular, it follows that the player playing at the high rate can draw the attention of people around him/her to the fact that he/she is playing the game at the high rate. As a result thereof, the desire to attract another's attention can be fulfilled, and the game can be rendered interesting.

In addition, in the gaming system 100, similar to the slot machines 1A to 1C of the first to third embodiments, in the rate setting process of the shop server 201, the set rate is set as the initial set rate when the figure presence flag has not been written. Therefore, the game can be played on the slot machine 101 even when the IC chip reader/writer 12c has not read the rate type information A, B.

Furthermore, in the shop server 201, in addition to the rate type information A, B, the rate is set in response to the use history information, such as the use frequency or the use time of the FIG. 70A, 70B. Therefore, an appropriate rate corresponding to the use history of the FIG. 70A, 70B can be set as the set rate.

The gaming machine and gaming system of the invention have so far been described, but can be modified in various ways without being limited to the aforementioned embodiments.

That is, in the aforementioned embodiments, a plurality of rates are related to one kind of figure using the rate groups in which the plurality of rates are related to the rate type information A, B indicative of the kind of the FIG. 70A, 70B. Alternatively, the configuration may be such that one rate is related to one kind of figure (the numeral ratio of figure to rate is made 1:1). In this case as well, it is preferable that the figure be sequentially varied in appearance from expensive-looking to inexpensive-looking in response to the rate level. This makes it possible not only to distinguish the high rate from the low rate, but also to distinguish one individual rate from another.

In addition, in the aforementioned embodiments, the rate is increased in stages in response to the use history information. Alternatively, the configuration may be such that the number of rates the player can select is increased in response to the use history information, and such that, similar to the slot machine 1A of the first embodiment, one rate is thus selected from such a plurality of rates using the touch panel 58.

Besides, in the aforementioned embodiments, the model portion 76a resembles a limousine automobile, and the model portion 76b resembles a compact car. However, the model portion 76a and the model portion 76b need only have such a three-dimensional shape that they can be compared with each other and that the player and people around him/her can recognize or suggest the high-rate figure and the low-rate figure. For example, the configuration may be such that the high-rate figure and the low-rate figure can be recognized or suggested by comparing a lion with a mouse, ajet plane with a car, a gold bar with a coin, and so on.

Moreover, in the aforementioned embodiments, the number of rates contained in the rate group is three, and the amounts are “$1, $5, and $10” (or “¢5, ¢25, and ¢50”). However, the configuration is not limited thereto, and the number and the amounts may be altered as appropriate.

Additionally, in the aforementioned embodiments, the use frequency has two thresholds: 50 times and 100 times. However, the number of thresholds and the number of times may be altered as appropriate. The same applies to the figure use frequency and the other use history information.

Furthermore, in the aforementioned embodiments, two kinds “A” and “B” are used as the kind of rate type information. In addition thereto, “C”, “D”, “E”, and the like may be used to increase the number of kinds as appropriate. Besides, rate type information corresponding to the local currency may be provided, for example, by allotting “A” and “B” to the American currency, “C” and “D” to the European currency, and “E” and “F” to the Japanese currency.

In addition, the gaming article is not limited to the figure, but may be a card, a cassette, or the like. Furthermore, in the aforementioned embodiments, the figure ID is stored in the IC chip 74, but the configuration is not limited thereto. The figure IC and the like may be stored in the gaming article in the following manner. That is, the data unique to the figure, such as the figure ID, is indicated by a barcode or a 2D code, and a seal or the like having the barcode or the 2D code printed thereon is attached to the gaming article, or the barcode or the 2D code are printed or stamped directly on the gaming article. To read the barcode, the 2D code, or the like, the IC chip reader/writer 12c serving as the reading unit is replaced with a barcode reader or the like. The 2D code is also called a 2D barcode, which includes, for example, QR Code (the trademark of Denso Wave Incorporated). This 2D code contains a large amount of information obtained by encoding data, having a capacity tens of times to hundreds of times that of the barcode.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gaming machine which pays out an award corresponding to a preset set rate out of a plurality of possible set rates, comprising:
a reading unit for reading, from a gaming article which stores rate type information indicating the type of each of the rates, the rate type information stored therein; and
a rate setting unit for setting, as the set rate, a rate out of the plurality of rates which corresponds to the rate type information read by the reading unit.

2. A gaming machine according to claim 1, further comprising a rate storage unit in which the rate type information and rate groups, each including a plurality of rates, are stored related to one another, wherein
the rate setting unit reads from the rate storage unit any one of a plurality of rates included in a rate group corresponding to the rate type information read by the reading unit, and sets the read rate as the set rate.

3. A gaming machine according to claim 2, further comprising:
a display unit for displaying a plurality of rates included in a rate group corresponding to the rate type information read by the reading unit; and
a rate selection unit which is used for a player to select any one of a plurality of rate displayed on the display unit, wherein
the rate setting unit sets as the set rate the rate selected by the rate selection unit.

4. A gaming machine according to claim 1, wherein
the reading unit can read, from a gaming article which stores rate type information indicating the type of each of the rates and use history information indicating a use history, the rate type information and the use history information which are stored therein, and wherein
the rate setting unit sets as the set rate a rate out of the plurality of rates which corresponds to the rate type information and the use history information which have been read by the reading unit.

5. A gaming machine according to any one of claims 1 to 4, wherein the rate setting unit, when the rate type information is not read by the reading unit, sets as the set rate an initial set rate of the lowest value of any of the rates.

6. A gaming system comprising: a gaming machine which pays out an award corresponding to a preset set rate out of a plurality of possible set rates; and a server which communicates with the gaming machine, wherein
the gaming machine includes:
a reading unit for reading, from a gaming article storing rate type information which indicates the type of each of the rates and use history information which indicates a use history, the rate type information and the use history information which are stored therein; and
a transmission unit for transmitting to the server the rate type information and the use history information which have been read by the reading unit, and wherein
the server includes:
a receiving unit for receiving the rate type information and the use history information which have been transmitted by the transmission unit; and
a rate transmission unit for transmitting, to the gaming machine, rate information which indicates a rate corresponding to the rate type information and the use history information which have been received by the receiving unit.
